(19) United States
(12) Patent Application Publication
(10) Pub. No.: US 2026/0195008 A1
(43) Pub. Date: Jul. 9, 2026

(54) ELECTRONIC DEVICE AND OPERATING METHOD THEREOF

(71) Applicant: SAMSUNG ELECTRONICS CO., LTD., Suwon-si (KR)

(72) Inventors: Eunseok CHOI, Suwon-si (KR); Sungho CHAE, Suwon-si (KR)

(73) Assignee: SAMSUNG ELECTRONICS CO., LTD., Suwon-si (KR)

(21) Appl. No.: 19/398,838

(22) Filed: Nov. 24, 2025

Related U.S. Application Data
(63) Continuation of application No. PCT/KR2025/018145, filed on Nov. 6, 2025.

(30) Foreign Application Priority Data
Jan. 9, 2025 (KR) 10-2025-0003743
Feb. 4, 2025 (KR) 10-2025-0013897

(51) Int. Cl. G06F 3/041; G06F 3/042; H04N 9/31

(52) U.S. Cl. CPC G06F 3/0418; G06F 3/0425; H04N 9/3185; H04N 9/3194

(57) ABSTRACT

Provided is an operating method of an electronic device, the operating method including obtaining rotation state information about the electronic device, identifying, by using the rotation state information about the electronic device, whether the electronic device is in a wall-projection orientation or a floor-projection orientation, deactivating, based on the electronic device being in the floor-projection orientation, a first sensor, and activating, based on the electronic device being in the wall-projection orientation, the first sensor.

### CROSS-REFERENCE TO RELATED APPLICATION(S)

This application is a bypass continuation application of International Patent Application No. PCT/KR2025/018145, filed on Nov. 6, 2025, which claims priority to Korean Patent Application No. 10-2025-0003743, filed on Jan. 9, 2025, and Korean Patent Application No. 10-2025-0013897, filed on Feb. 4, 2025, the disclosures of which are incorporated herein by reference in their entireties.

### TECHNICAL FIELD

Embodiments of the disclosure relate to an electronic device and an operating method thereof, and more particularly, to an electronic device capable of performing keystone correction, and an operating method thereof.

### BACKGROUND ART

With the advancement of optical technology, there may be various types of projectors.

Projectors may refer to electronic devices for projecting light onto a projection surface/screen, to form an image on the projection surface/screen. When the angle between the direction of light projected from the projector and the projection surface is equal to a predetermined angle, a rectangular image may be formed on the screen. However, when the angle between the direction of the light projected from the projector and the projection surface is not equal to the predetermined angle, warping may occur in the vertical and/or horizontal direction of the image, or a rotated image is formed on the projection surface. Such warping may be referred to as ‘keystone’ or ‘keystone effect’.

The projector may use a tilt sensor provided therein to obtain an angle at which the sensor is rotated with respect to the direction of gravity. In addition, the projector may use a distance sensor, such as a time-of-flight (ToF) sensor, to obtain a distance between the screen and the projector, or three-dimensional information. The ToF sensor may accurately measure distance and depth information with respect to the projection surface via an infrared transmitting unit and an infrared receiving unit.

The projector may perform an auto keystone correction by identifying a positional relationship between the screen and the projector by using a rotation angle obtained via the sensor, to correct the image.

Furthermore, a technology has been developed that may allow an image projected on a projection surface to be used as a physical touch screen, by using an infrared-based touch function. This technology may enable detection of a touch on a projection surface via transmission and reception of infrared (IR) signals.

In a projector capable of performing both a ToF sensing function and an IR-based touch function, when a measurement direction of a ToF sensor overlaps with an IR touch area, an issue may arise in which the IR-based touch function is not properly implemented due to interference between an infrared signal transmitted from the ToF sensor and an infrared signal used for touch detection.

### DISCLOSURE

### Technical Solution

According to an aspect of an embodiment of the disclosure, an electronic device may include a projection unit comprising projection circuitry; at least one processor comprising processing circuitry; memory storing instructions that, when executed by the at least one processor individually or collectively, cause the electronic device to identify, by using the rotation state information about the electronic device, whether the electronic device is in a wall-projection orientation or a floor-projection orientation, deactivate, based on the electronic device being in the floor-projection orientation, a first sensor, and activate, based on the electronic device being in the wall-projection orientation, the first sensor.

The floor-projection orientation may be an orientation of the electronic device when a projection surface is horizontal to a ground surface. The wall-projection orientation may be an orientation of the electronic device when the projection surface is perpendicular to the ground surface.

The instructions, when executed by the at least one processor individually or collectively, may further cause the electronic device to, under control of the at least one processor, obtain the rotation state information, based on raw data obtained via a second sensor, wherein the rotation state information comprises a pitch angle and a roll angle, the pitch angle and the roll angle being rotation angles of the electronic device with respect to a direction of gravity and identify whether the electronic device is in the wall-projection orientation or the floor-projection orientation, by identifying whether the pitch angle and the roll angle are within reference angle ranges. The second sensor may be an acceleration sensor.

The instructions, when executed by the at least one processor individually or collectively, may further cause the electronic device to, under control of the at least one processor, identify, based on the electronic device being in the floor-projection orientation, whether a third sensor is activated, maintain, based on the third sensor being activated, the first sensor in a deactivated state, and switch, based on the third sensor being deactivated, the first sensor to an activated state. The first sensor may be a time-of-flight (ToF) sensor. The third sensor may be an infrared (IR) touch sensor.

The third sensor may be mounted on a holder that is attachable to and detachable from the electronic device. The third sensor, in response to the electronic device being attached to the holder, may be connected to the electronic device and activated.

The instructions, when executed by the at least one processor individually or collectively, may further cause the electronic device to, under control of the at least one processor, obtain, in response to the electronic device being in the floor-projection orientation and the first sensor being in the deactivated state, keystone correction information pre-stored in the memory, and perform keystone correction by using the obtained keystone correction information.

The keystone correction information may comprise at least one of coordinate values of a keystone screen or a distance value for focus adjustment.

The instructions, when executed by the at least one processor individually or collectively, may further cause the electronic device to, under control of the at least one processor, based on receiving a keystone correction command signal via a user input when the electronic device is in the floor-projection orientation, deactivate the third sensor and activate the first sensor, and perform keystone correction based on information obtained via the first sensor.

The instructions, when executed by the at least one processor individually or collectively, may further cause the electronic device to, under control of the at least one processor, after performing the keystone correction based on the information obtained via the first sensor, deactivate the first sensor and activate the third sensor.

The instructions, when executed by the at least one processor individually or collectively, may further cause the electronic device to, under control of the at least one processor, indicate, based on receiving the keystone correction command signal, a suspension of touch recognition, and after performing the keystone correction, indicate that touch recognition is possible.

The instructions, when executed by the at least one processor individually or collectively, may further cause the electronic device to, under control of the at least one processor, based on the electronic device being in the wall-projection orientation, prevent an IR touch function from being performed regardless of whether the third sensor is activated.

According to another aspect of an embodiment of the disclosure, an operating method of an electronic device may include obtaining rotation state information about the electronic device; identifying, by using the rotation state information about the electronic device, whether the electronic device is in a wall-projection orientation or a floor-projection orientation; deactivating, based on the electronic device being in the floor-projection orientation, a first sensor; and activating, based on the electronic device being in the wall-projection orientation, the first sensor.

The obtaining of the rotation state information about the electronic device may include obtaining the rotation state information about the electronic device based on raw data obtained via a second sensor. The rotation state information may include a pitch angle and a roll angle, the pitch angle and the roll angle being rotation angles of the electronic device with respect to a direction of gravity. The identifying of whether the electronic device is in the wall-projection orientation or the floor-projection orientation may include identifying whether the electronic device is in the wall-projection orientation or the floor-projection orientation, by identifying whether the pitch angle and the roll angle are within reference angle ranges. The second sensor may be an acceleration sensor.

The operating method may further include identifying, based on the electronic device being in the floor-projection orientation, whether a third sensor is activated; maintaining, based on the third sensor being activated, the first sensor in a deactivated state; and switching, based on the third sensor being deactivated, the first sensor to an activated state. The first sensor is may be time-of-flight (ToF) sensor. The third sensor may be an infrared (IR) touch sensor.

The operating method may further include obtaining, in response to the electronic device being in the floor-projection orientation and the first sensor being in the deactivated, pre-stored keystone correction information; and performing keystone correction by using the obtained keystone correction information.

The operating method may further include based on receiving a keystone correction command signal via a user input when the electronic device is in the floor-projection orientation, deactivating the third sensor and activating the first sensor; and performing keystone correction, based on information obtained via the first sensor.

The operating method may further include after performing the keystone correction based on the information obtained via the first sensor, deactivating the first sensor and activating the third sensor

The operating method may further include indicating, based on receiving the keystone correction command signal, a suspension of touch recognition; and after performing the keystone correction, indicating that touch recognition is possible.

The operating method may further include based on the electronic device being in the wall-projection orientation, preventing an IR touch function from being performed, regardless of whether the third sensor is activated.

According to another aspect of an embodiment of the disclosure, a computer-readable recording medium having recorded thereon a program for causing a computer to execute at least obtain rotation state information about the electronic device; identify, by using the rotation state information about the electronic device, whether the electronic device is in a wall-projection orientation or a floor-projection orientation; deactivate, based on the electronic device being in the floor-projection orientation, a first sensor; and activate, based on the electronic device being in the wall-projection orientation, the first sensor.

### BRIEF DESCRIPTION OF DRAWINGS

Various embodiments in accordance with the disclosure will be described with reference to the drawings, in which:

FIG. 1 illustrates an example diagram of an electronic device identifying its orientation by using a sensor, according to an embodiment of the disclosure

FIG. 2 illustrates an example diagram of an electronic device operating in a wall-projection orientation, according to an embodiment of the disclosure

FIG. 3 illustrates an example diagram of an electronic device operating in a floor-projection orientation, according to an embodiment of the disclosure

FIG. 4 illustrates an example block diagram of an electronic device according to an embodiment of the disclosure

FIG. 5 illustrates an example block diagram of an electronic device according to an embodiment of the disclosure;

FIG. 6 illustrates an example block diagram of an electronic device according to an embodiment of the disclosure;

FIG. 7 illustrates an example block diagram of an electronic device according to an embodiment of the disclosure.

FIG. 8 illustrates an example diagram illustrating keystone effects corresponding to rotation angles, according to an embodiment of the disclosure;

FIG. 9 illustrates an example diagram illustrating image distortion due to a keystone effect, and an effect of keystone correction, according to an embodiment of the disclosure;

FIG. 10 illustrates an example flowchart of an operating method of an electronic device, according to an embodiment of the disclosure; and

FIG. 11 illustrates an example flowchart of an operating method of an electronic device, according to an embodiment of the disclosure.

### DETAILED DESCRIPTION

Phrases of form such as “at least one of A, B, and C,” or “at least one of A, B or C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such language is not generally intended to imply that certain embodiments require at least one of A, at least one of B and at least one of C each to be present.

An embodiment of the disclosure will be described in detail with reference to the accompanying drawings to enable those of skill in the art to perform embodiments of the disclosure without any difficulty. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Other variations are within spirit of disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Although the terms used herein are generic terms, which are currently widely used and are selected by taking into consideration functions thereof, the meanings of the terms may vary according to intentions of those of ordinary skill in the art, legal precedents, or the advent of new technology. Thus, the terms should be defined not by simple appellations thereof but based on the meanings thereof and the context of descriptions throughout the disclosure.

In addition, terms used herein are for describing a particular embodiment of the disclosure, and are not intended to limit the disclosure.

Use of any and all examples, or exemplary language provided herein, is intended merely to better illuminate embodiments of disclosure and does not pose a limitation on scope of disclosure unless otherwise claimed. No language in specification should be construed as indicating any non-claimed element as essential to practice of disclosure

It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to,” or “directly coupled to” another element or layer, there are no intervening elements or layers present.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term. In addition, when there is no description explicitly specifying an order of operations of a method according to the disclosure, the operations may be performed in an appropriate order. The disclosure is not limited to the described order of the operations.

Some embodiments of the disclosure may be represented by block components and various process operations. Some or all of the functional blocks may be implemented by any number of hardware and/or software elements that perform particular functions. For example, the functional blocks of the disclosure may be embodied by at least one microprocessor or by circuit components for a certain function. In addition, for example, the functional blocks of the disclosure may be implemented by using various programming or scripting languages. The functional blocks may be implemented by using various algorithms executable by one or more processors. In addition, the disclosure may employ known technologies for electronic settings, signal processing, and/or data processing. Terms such as “mechanism”, “element”, “unit”, or “component” may be used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

In addition, as used herein, the terms such as “ . . . er”, “ . . . unit”, “ . . . module”, etc., denote a unit that performs at least one function or operation, which may be implemented as hardware or software or a combination thereof.

Terms such as “comprising,” “having,” “including,” and “containing” are to be construed as open-ended terms (meaning “including, but not limited to,”) unless otherwise noted. Recitation of ranges of values herein are merely intended to serve as a shorthand method of referring individually to each separate value falling within range, unless otherwise indicated herein and each separate value is incorporated into specification as if it were individually recited herein.

Terms such as “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

In addition, unless otherwise noted or contradicted by context, term “plurality” indicates a state of being plural (e.g., “a plurality of items” indicates multiple items). Number of items in a plurality is at least two, but can be more when so indicated either explicitly or by context. Further, unless stated otherwise or otherwise clear from context, phrase “based on” means “based at least in part on” and not “based solely on.

Terms such as “first,” “second,” “third,” “fourth,” etc. are used merely to distinguish elements from one another and thus do not denote any particular order unless an order is specifically described. For example, the term “second” may be used without using the term “first”. Also, although the terms “first,” “second,” “third,” and so on may be used herein to describe various elements, components, regions, layers and/or sections, these elements, components, regions, layers and/or sections should not be limited by these terms.

In addition, as used herein, the term “user” may refer to a person who uses an electronic device, and may include a consumer, an evaluator, a viewer, an administrator, or an installer.

The disclosure will be described in detail with reference to the accompanying drawings.

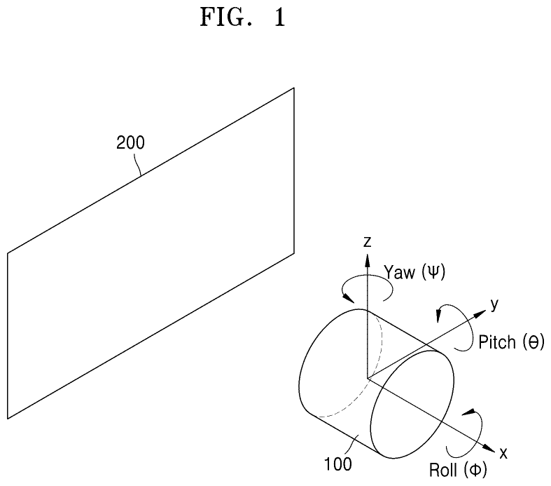

FIG. 1 illustrates an example diagram of an electronic device identifying its orientation by using a sensor, according to an embodiment of the disclosure.

Referring to FIG. 1, an electronic device 100 may be an electronic device capable of outputting an image.

In an embodiment of the disclosure, the electronic device 100 may be a projector for projecting an image onto a projection surface. Alternatively, the electronic device 100 may be implemented as various types of electronic devices that perform a projector function together with functions of other electronic devices. The electronic device 100 may be stationary or mobile.

In an embodiment of the disclosure, the electronic device 100 may include a sensor. The sensor may obtain state information about the electronic device 100 and/or state information about the surroundings of the electronic device 100. In an embodiment of the disclosure, the electronic device 100 may obtain, by using the sensor, state information about the electronic device 100, such as acceleration, tilt (angle), vibration, shock, or movement.

In an embodiment of the disclosure, the electronic device 100 may obtain rotation state information about the electronic device 100 by, for example, obtaining raw data using the sensor. In an embodiment of the disclosure, the rotation state information about the electronic device 100 may include information about a tilt or an angle of the electronic device 100. In an embodiment of the disclosure, the rotation state information about the electronic device 100 may include a rotation angle of the electronic device 100 with respect to the direction of gravity. In an embodiment of the disclosure, the rotation angle of the electronic device 100 may be defined based on an X-axis, a Y-axis, and a Z-axis of the electronic device 100 projecting an image onto the projection surface.

As illustrated in FIG. 1, the Z-axis may refer to a direction of gravity or a direction opposite to the gravity. The Y-axis may refer to a direction that is perpendicular to the Z-axis and parallel to a widthwise direction of the projection surface (e.g., horizontal direction, and X axis may refer to a direction that is perpendicular to the Z-axis, corresponds to an optical axis direction connecting the projection surface to the electronic device 100, and is parallel to a lengthwise direction of the projection surface.

In an embodiment of the disclosure, a roll angle φ may refer to a rotation angle about the X-axis a pitch angle θ may refer to a rotation angle about the Y-axis and a yaw angle ψ may refer to a rotation angle about the Z-axis.

In an embodiment of the disclosure, the electronic device 100 may include an acceleration sensor as a tilt sensor. In an embodiment of the disclosure, the acceleration sensor may identify a change in velocity of the electronic device 100. In an embodiment of the disclosure, the electronic device 100 may obtain raw data (e.g., direct measurements or readings captured by sensing devices such as the acceleration sensor) for each axis by using the acceleration sensor.

In an embodiment of the disclosure, the acceleration sensor may be a 3-axis acceleration sensor. In a case in which an acceleration sensor is a 3-axis acceleration sensor, the acceleration sensor 131 may obtain raw data by measuring gravitational acceleration values for the X-axis, the Y-axis, and the Z-axis, respectively. In an embodiment of the disclosure, the acceleration sensor may be a 3-axis acceleration sensor, a 6-axis sensor including a 3-axis acceleration sensor and a 3-axis gyro sensor, or a 9-axis sensor including a 3-axis acceleration sensor, a 3-axis gyro sensor, and a 3-axis geomagnetic sensor, but is not limited thereto.

In an embodiment of the disclosure, the electronic device 100 may obtain a rotation angle with respect to the direction of gravity by using the raw data obtained by the acceleration sensor. In an embodiment of the disclosure, the electronic device 100 may obtain at least one of a pitch angle or a roll angle with respect to the direction of gravity by using the raw data obtained by the acceleration sensor.

In an embodiment of the disclosure, the electronic device 100 may include a distance sensor. In an embodiment of the disclosure, the distance sensor may include a time-of-flight (ToF) sensor. The ToF sensor may include a three-dimensional (3D) ToF sensor. In an embodiment of the disclosure, the electronic device 100 may obtain a rotation angle of the electronic device 100 by using the ToF sensor to emit an infrared signal and measure a time taken for a reflected signal to return. The ToF sensor may accurately measure distance and depth information with respect to the projection surface via an infrared transmitting unit and an infrared receiving unit.

In an embodiment of the disclosure, the electronic device 100 may obtain, by using the ToF sensor, an angle formed by the projection surface and the electronic device 100, a distance between the projection surface and the electronic device 100, the shape of the projection surface, and the like. In an embodiment of the disclosure, the electronic device 100 may estimate a tilt of the projection surface by measuring, with the ToF sensor, distances between the electronic device 100 and the projection surface at a plurality of points.

In an embodiment of the disclosure, the electronic device 100 may obtain rotation angles of the electronic device 100 about the X-axis, the Y-axis, and the Z-axis by using data obtained via the acceleration sensor and the ToF sensor.

In an embodiment of the disclosure, the electronic device 100 may obtain an indication of a geometric relationship between the projection surface and the electronic device 100 by using the rotation angles, and perform auto keystone correction based on the geometric relationship. In an embodiment of the disclosure, in response to a rotation angle being greater than or equal to a reference rotation angle, the electronic device 100 may perform image processing for auto keystone correction based on the rotation angles. In more detail, the electronic device 100 may perform image processing for correcting a rotation angle that has a value greater than or equal to a reference rotation angle among the pitch angle, the roll angle, and the yaw angle.

In an embodiment of the disclosure, the electronic device 100 may be a projector capable of performing an infrared (IR) touch interaction. In the disclosure, the IR touch interaction function may refer to a technique of using an image projected on a projection surface as a touch screen by using an IR-based touch function.

In an embodiment of the disclosure, the electronic device 100 may use an IR transceiver to perform the IR touch interaction function.

In the disclosure, the IR transceiver used to perform the IR touch interaction function may refer to an IR touch sensor. The IR touch sensor may include an IR transmitting device and an IR receiving device.

In an embodiment of the disclosure, the electronic device 100 may project an infrared signal onto a projection surface by using the IR touch sensor. When a user touches an image or a screen projected on the projection surface with a finger or a tool (e.g., stylus) while an IR signal is being projected onto the projection surface by the IR transmitting device of the IR touch sensor, the IR receiving device of the IR touch sensor may collect an IR signal reflected from the user's finger or stylus. The electronic device 100 may track a contact position of the user's finger or stylus by detecting a blockage or a reflection of an IR light beam and calculating a touch position.

In an embodiment of the disclosure, the electronic device 100 may perform the IR touch interaction function when in a floor-projection orientation (e.g., attitude), in which a projection surface is formed on a floor surface. In an embodiment of the disclosure, the floor-projection orientation may be an orientation of the electronic device 100 when the projection surface, which is an image or a screen projected by the electronic device 100, is horizontal to a ground surface. That is, the orientation of the electronic device 100 when a projection surface is formed on a floor surface horizontal to a ground surface may be referred to as the floor-projection orientation. In an embodiment of the disclosure, when the electronic device 100 is in the floor-projection orientation, the electronic device 100 may perform an IR touch interaction operation.

In the disclosure, unlike the floor-projection orientation, the orientation of the electronic device 100 when a projection surface is formed on a wall surface perpendicular to a ground surface, as illustrated in FIG. 1, may be referred to as a wall-projection orientation.

In an embodiment of the disclosure, when the electronic device 100 is in the wall-projection orientation, the electronic device 100 may not perform the IR touch interaction operation.

When the electronic device 100 is in the floor-projection orientation and obtains raw data via the ToF sensor using an infrared signal, interference may occur between the IR signal used by the ToF sensor and the IR signal used by the IR touch sensor for performing the IR touch interaction function.

That is, because both the ToF sensor and the IR touch sensor use infrared signals, their frequency bands may be identical to each other or may partially overlap with each other. In addition, because signal directions in which the ToF sensor and the IR touch sensor emit or receive IR signals are identical or similar to each other, their projection areas may be identical to each other or may partially overlap with each other, such that the IR signals are likely to be mixed.

In this case, an issue may arise in which the IR receiving device of the IR touch sensor misidentifies an IR signal emitted from the ToF sensor as a signal emitted from the IR transmitting device of the IR touch sensor, and thus fails to accurately detect a touch position.

In an embodiment of the disclosure, the electronic device 100 may deactivate the ToF sensor when the electronic device 100 is in the floor-projection orientation, to prevent the ToF sensor from affecting the IR touch interaction operation.

In an embodiment of the disclosure, the electronic device 100 may obtain rotation state information about the electronic device 100. In an embodiment of the disclosure, the rotation state information may include rotation angles. In an embodiment of the disclosure, the electronic device 100 may obtain rotation angles with respect to the direction of gravity, which are obtained via the acceleration sensor. In an embodiment of the disclosure, the rotation angles with respect to the direction of gravity obtained via the acceleration sensor may include a pitch angle and a roll angle.

In an embodiment of the disclosure, the electronic device 100 may identify whether the orientation of the electronic device 100 is the floor-projection orientation or the wall-projection orientation, by determining whether the pitch angle and the roll angle are within reference angle ranges.

FIG. 1 illustrates a case in which the electronic device 100 is in the wall-projection orientation. As illustrated in FIG. 1, assuming that the pitch angle and the roll angle of the electronic device 100 in the wall-projection orientation are 0 degrees each, when the electronic device 100 is changed to the floor-projection orientation, the roll angle may remain 0 degrees, but the pitch angle may be changed to 90 degrees.

In an embodiment of the disclosure, when the electronic device 100 determines, by using the pitch angle and the roll angle, that the electronic device 100 is in the wall-projection orientation, the electronic device 100 may activate the ToF sensor.

In an embodiment of the disclosure, the electronic device 100 may not perform the IR touch interaction operation in the wall-projection orientation. That is, the electronic device 100 may prevent the IR touch function from being performed when in the wall-projection orientation, regardless of whether the IR touch sensor is activated.

In an embodiment of the disclosure, when in the wall-projection orientation, the electronic device 100 may activate the ToF sensor to calculate a tilt of a screen or a projection surface by measuring, with the ToF sensor, distance information between the electronic device 100 and the projection surface. The electronic device 100 may perform auto keystone correction for automatically correcting distortion of a projected image, and/or auto focus adjustment, based on the tilt of the projection surface.

In an embodiment of the disclosure, when the electronic device 100 determines that the pitch angle and the roll angle are within the reference angle ranges corresponding to the floor-projection orientation, for example, that the roll angle is within a tolerance interval around 0 degrees and the pitch angle is within a tolerance interval around 90 degrees, the electronic device 100 may determine that it is in the floor-projection orientation. In an embodiment of the disclosure, based on the electronic device 100 being in the floor-projection orientation, the electronic device 100 may deactivate the ToF sensor.

In an embodiment of the disclosure, based on the electronic device 100 being in the floor-projection orientation, the electronic device 100 may identify whether the IR touch sensor used to perform the IR touch interaction function is activated. In an embodiment of the disclosure, the electronic device 100 may determine whether to continue to deactivate the ToF sensor or to activate the ToF sensor, depending on whether the IR touch sensor is activated (e.g., when it is not connected to the electronic device 100, or is connected to the electronic device 100 and in an ON state).

In an embodiment of the disclosure, when the IR touch sensor is not in operation, for example, when the IR touch sensor is deactivated (e.g., when it is not connected to the electronic device 100, or is connected to the electronic device 100 but is in an OFF state), the electronic device 100 may switch the ToF sensor to an activated state. A case in which the electronic device 100 is in the floor-projection orientation but the IR touch sensor is deactivated, may indicate that a user does not intend to perform the IR touch interaction operation.

In this case, the electronic device 100 may change the ToF sensor, which is in a deactivated state, to an activated state. For example, the electronic device 100 may measure, by using the ToF sensor, distances between the electronic device 100 and the projection surface at a plurality of points, by controlling the ToF sensor to be turned on and thus in the activated state. The electronic device 100 may obtain information about an angle or a tilt between the projection surface and the electronic device 100, the shape of the projection surface, and the like, by using a plurality of distances obtained via the ToF sensor. The electronic device 100 may perform auto keystone correction and/or auto focus adjustment based on a relationship between the projection surface and the electronic device 100, by using data obtained via the ToF sensor.

In an embodiment of the disclosure, when the orientation of the electronic device 100 is the floor-projection orientation and the IR touch sensor is in the activated state, the electronic device 100 may continuously maintain the ToF sensor in the deactivated state. In an embodiment of the disclosure, the activated state of the IR touch sensor may refer to a state in which the IR touch sensor is coupled to the electronic device 100, and the IR transmitting device and the IR receiving device included in the IR touch sensor are turned ON and are capable of operating normally.

In an embodiment of the disclosure, when the ToF sensor is turned off, it is impossible to obtain raw data via the ToF sensor, and thus, auto keystone correction and/or auto focus adjustment, which are performed based on raw data obtained via the ToF sensor, cannot be performed.

In an embodiment of the disclosure, when the electronic device 100 maintains the ToF sensor in the deactivated state because the orientation of the electronic device 100 is the floor-projection orientation and the IR touch sensor is activated, the electronic device 100 may perform keystone correction by using keystone correction information pre-stored in memory, instead of performing auto keystone correction.

The keystone correction performed by the electronic device 100 by using the keystone correction information pre-stored in the memory may be distinguished from the auto keystone correction that corrects distortion caused by a screen tilt by using real-time distance values obtained via the ToF sensor.

In an embodiment of the disclosure, keystone correction information that is used for keystone correction when the electronic device 100 is in the floor-projection orientation may be pre-stored in memory of the electronic device 100. In an embodiment of the disclosure, the keystone correction information may include at least one of coordinate values of a keystone screen or distance values for focus adjustment.

In an embodiment of the disclosure, when the ToF sensor is in the deactivated state, the electronic device 100 may obtain the keystone correction information from the memory and perform keystone correction by using the keystone correction information.

In an embodiment of the disclosure, when the electronic device 100 is in the floor-projection orientation, the electronic device 100 may receive a keystone correction command signal via a user input. For example, the user may input a keystone correction command signal by using a control device such as a remote controller. There may be a case in which it is difficult to accurately correct distortion caused by a screen tilt by using the keystone correction information pre-stored in the memory, such as when the floor surface is not evenly horizontal or has depth variations like stairs. In this case, the user may allow distortion caused by a screen tilt to be corrected more accurately by causing, via a user input, the electronic device 100 to perform keystone correction.

In an embodiment of the disclosure, when the electronic device 100 receives a keystone correction command signal via a user input while in the floor-projection orientation, the electronic device 100 may activate the ToF sensor and deactivate the IR touch sensor.

For example, when a keystone correction command signal is received from the user while the ToF sensor is deactivated based on the orientation of the electronic device 100 being the floor-projection orientation, the electronic device 100 may change the ToF sensor that is in the deactivated state to the activated state, and change the IR touch sensor that is in the activated state to the deactivated state.

In response to the keystone correction command signal, the electronic device 100 in the floor-projection orientation may activate the ToF sensor to measure distance information between the electronic device 100 and the projection surface, and calculate a tilt of the projection surface by using the distance information. The electronic device 100 may perform keystone correction and/or focus adjustment for correcting image distortion or focus based on the tilt of the projection surface.

In an embodiment of the disclosure, after performing keystone correction according to the keystone correction command signal from the user, the electronic device 100 may change the ToF sensor to the deactivated state and change the IR touch sensor to the activated state. In an embodiment of the disclosure, the electronic device 100 may perform the IR touch interaction operation by using the projection surface for which the keystone correction has been performed.

In an embodiment of the disclosure, when the electronic device 100 receives a keystone correction command signal via a user input while in the floor-projection orientation, the electronic device 100 may output information indicating a suspension of touch recognition. The information indicating the suspension of touch recognition may include at least one of an audio signal or a video signal. For example, the electronic device 100 may notify the user that the IR touch interaction operation cannot be performed, by displaying, on the projection surface, content indicating that touch recognition is temporarily suspended, or by outputting a voice signal with such content through a speaker.

In an embodiment of the disclosure, after performing keystone correction according to a keystone correction command signal via a user input while in the floor-projection orientation, the electronic device 100 may output information indicating that touch recognition is possible. For example, the electronic device 100 may notify the user that the IR touch interaction operation is executable, by projecting, onto the projection surface, content indicating that touch recognition is possible, or by outputting a voice signal with such content.

As such, according to an embodiment of the disclosure, the electronic device 100 may obtain a rotation state of the electronic device 100 via the acceleration sensor, and by using the rotation state, identify whether the orientation of the electronic device 100 is the floor-projection orientation or the wall-projection orientation.

According to an embodiment of the disclosure, the electronic device 100 may deactivate the ToF sensor when in the floor-projection orientation, and activate the ToF sensor when in the wall-projection orientation.

According to an embodiment of the disclosure, when in the floor-projection orientation, the electronic device 100 may identify whether the IR touch sensor used for IR touch interaction is activated, and when the IR touch sensor is activated, maintain the ToF sensor in the deactivated state to control the ToF sensor to prevent it from affecting the function of the IR touch sensor.

According to an embodiment of the disclosure, when the electronic device 100 is in the floor-projection orientation and the ToF sensor is in the deactivated state, the electronic device 100 may correct image distortion even when the ToF sensor is turned off, by performing keystone correction by using the keystone correction information pre-stored in the memory.

According to an embodiment of the disclosure, when the electronic device 100 receives a keystone correction command signal via a user input while in the floor-projection orientation, the electronic device 100 may deactivate the IR touch sensor and activate the ToF sensor, so as to perform keystone correction based on real-time distance information obtained via the ToF sensor.

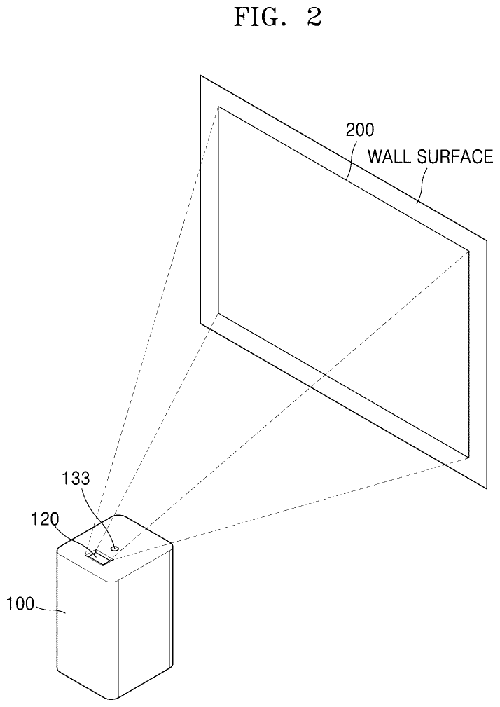

FIG. 2 is an example diagram of an electronic device operating in a wall-projection orientation, according to an embodiment of the disclosure.

In an embodiment of the disclosure, the electronic device 100 may include a projection unit 120. In an embodiment of the disclosure, the projection unit 120 is a component that projects light for expressing an image. The projection unit 120 may include various components such as a light source, a projection lens, or a reflector.

In an embodiment of the disclosure, the electronic device 100 may operate in the wall-projection orientation. As illustrated in FIG. 2, the wall-projection orientation may be an orientation of the electronic device 100 when it projects an image or a screen (e.g., projection surface 200) in a direction toward a wall surface that is perpendicular to a horizontal plane. When the electronic device 100 is in the wall-projection orientation, the projection surface 200 may be formed parallel to the wall surface.

In an embodiment of the disclosure, the electronic device 100 may include an acceleration sensor. In an embodiment of the disclosure, the electronic device 100 may obtain a pitch angle and a roll angle among rotation angles with respect to the direction of gravity, by using the acceleration sensor included in the electronic device 100.

In an embodiment of the disclosure, when the electronic device 100 is in the wall-projection orientation, the pitch angle and the roll angle, which are rotation angles between the electronic device 100 and the projection surface 200, may each be 0 degrees or be within a tolerance interval around 0 degrees.

In an embodiment of the disclosure, the electronic device 100 may identify, by using the pitch angle and the roll angle, whether the orientation of the electronic device 100 is the floor-projection orientation or the wall-projection orientation. In an embodiment of the disclosure, as illustrated in FIG. 2, when the projection surface 200 is formed on a wall surface, the electronic device 100 may determine that its orientation is the wall-projection orientation.

In an embodiment of the disclosure, the electronic device 100 may include a ToF sensor 133. In an embodiment of the disclosure, the ToF sensor 133 may be arranged on a front surface of the electronic device 100 facing the projection surface 200, or at an upper end of the electronic device 100. However, this is only an example, and the arrangement or position of the ToF sensor 133 may be variously modified depending on the appearance or structure of the electronic device 100.

In an embodiment of the disclosure, based on the orientation of the electronic device 100 being the wall-projection orientation as illustrated in FIG. 2, the electronic device 100 may control the ToF sensor 133 such that it is turned on to be in an activated state.

In an embodiment of the disclosure, based on the electronic device 100 being in the wall-projection orientation, the electronic device 100 may perform control such that the IR touch function is not performed. For example, when the electronic device 100 is in the wall-projection orientation, the electronic device 100 may control the IR touch sensor to be turned off. Alternatively, when in the wall-projection orientation, the electronic device 100 may control the IR receiving device included in the IR touch sensor such that the IR receiving device does not detect a touch, regardless of whether the IR touch sensor is turned on or off.

In an embodiment of the disclosure, based on the electronic device 100 being in the wall-projection orientation, the electronic device 100 may measure a distance and a depth between the projection surface 200 and the electronic device 100 by using the ToF sensor 133.

In an embodiment of the disclosure, the electronic device 100 may obtain rotation angles of the electronic device 100 about three axis directions relative to the projection surface 200 by using the acceleration sensor and the ToF sensor 133, and correct screen distortion by performing auto keystone correction based on the rotation angles.

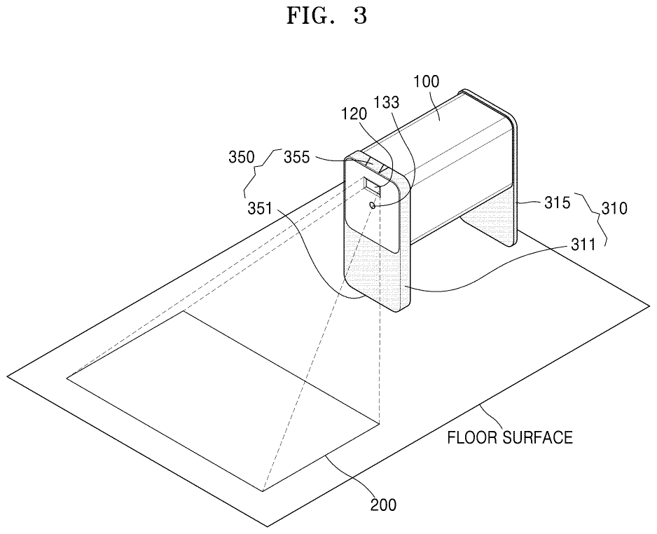

FIG. 3 is an example diagram of an electronic device operating in a floor-projection orientation, according to an embodiment of the disclosure.

In an embodiment of the disclosure, the electronic device 100 may operate in the floor-projection orientation.

As illustrated in FIG. 3, the electronic device 100 may be in the floor-projection orientation. In an embodiment of the disclosure, the floor-projection orientation may be an orientation of the electronic device 100 when it projects an image or a screen in a horizontal plane direction. That is, as illustrated in FIG. 3, when the electronic device 100 is in the floor-projection orientation, light projected by the projection unit 120 may form the projection surface 200 on a floor surface parallel to a horizontal plane.

In addition to the orientation illustrated in FIG. 2 being referred to as the wall-projection orientation in which the electronic device 100 is in a substantially upright or “standing” orientation, the orientation in which the electronic device 100 is in a substantially horizontal or “lying down” orientation, as illustrated in FIG. 3, may refer to floor-projection orientation.

Assuming that the pitch angle and the roll angle of the electronic device 100 in the wall-projection orientation are 0 degrees each, when the electronic device 100 is in the floor-projection orientation, the roll angle may be 0 degrees, and the pitch angle may be 90 degrees.

However, an orientation in which the electronic device 100 is lying on its side (e.g., where both the pitch angle and the roll angle are 90 degrees or −90 degrees) may not be the floor-projection orientation.

In an embodiment of the disclosure, the electronic device 100 may obtain a rotation angle with respect to the direction of gravity by using the acceleration sensor.

In an embodiment of the disclosure, the electronic device 100 may identify whether its orientation is the floor-projection orientation, by using a pitch angle and a roll angle obtained via the acceleration sensor.

In an embodiment of the disclosure, the electronic device 100 may identify whether its orientation is the floor-projection orientation, by determining whether the pitch angle and the roll angle obtained via the acceleration sensor are within reference ranges. For example, when the roll angle is within a tolerance interval around 0 degrees and the pitch angle is within a tolerance interval around 90 degrees, the electronic device 100 may determine that its orientation is the floor-projection orientation.

In an embodiment of the disclosure, based on the orientation of the electronic device 100 being the floor-projection orientation, the electronic device 100 may deactivate the ToF sensor 133.

In an embodiment of the disclosure, based on the orientation of the electronic device 100 being the floor-projection orientation, the electronic device 100 may identify whether an IR touch sensor 350 is activated.

In an embodiment of the disclosure, when in the floor-projection orientation, the electronic device 100 may deactivate the ToF sensor 133 and simultaneously identify whether the IR touch sensor 350 is activated, or it may deactivate the ToF sensor 133 and then identify whether the IR touch sensor 350 is activated.

In an embodiment of the disclosure, the IR touch sensor 350 may be integrated into in the electronic device 100, or may be separate from the electronic device 100.

In an embodiment of the disclosure, the IR touch sensor 350 may be mounted on a holder or cradle that may be detachably coupled to the electronic device 100. In an embodiment of the disclosure, when the IR touch sensor 350 is mounted on a holder 310 that may be detachably coupled to the electronic device 100, a user may mount the electronic device 100 on the holder 310 such that the electronic device 100 and the holder 310 are coupled to each other, to allow the electronic device 100 to perform the IR touch interaction function.

In an embodiment of the disclosure, in response to the electronic device 100 being coupled to the holder 310, the IR touch sensor 350 may be connected to the electronic device 100 and activated.

FIG. 3 illustrates a case in which the IR touch sensor 350 is mounted on the holder 310, which is separate from the electronic device 100, according to an embodiment of the disclosure. As illustrated in FIG. 3, the holder 310 may include a front holder 311 and a rear holder 315. For example, as illustrated in FIG. 3, the front holder 311 may support a region of the electronic device 100 facing the projection surface 200, and the rear holder 315 may support an opposite region farther from the projection surface 200.

However, the shape and structure of the holder 310 illustrated in FIG. 3 are non-limiting examples, and there may be various modifications to the shape, structure, form, and the like to the holder 310 (e.g., use of a different number of holders).

In an embodiment of the disclosure, in a case in which the electronic device 100 is detachable from the holder 310, the electronic device 100 and the holder 310 may be coupled to each other through physical grooves and protrusions for mutual fastening. In an embodiment of the disclosure, the grooves and protrusions formed on the electronic device 100 and the holder 310 may be formed in one or more regions of a portion where the electronic device 100 and the holder 310 are in contact.

In an embodiment of the disclosure, the electronic device 100 and the holder 310 may be coupled to each other via an electrical connector. The electrical connector may be located on the grooves and protrusions formed on the electronic device 100 and the holder 310.

In an embodiment of the disclosure, the electronic device 100 may include a first connector, and the holder 310 may include a second connector. In an embodiment of the disclosure, the electronic device 100 and the holder 310 may be electrically coupled to each other via the first connector and the second connector.

In an embodiment of the disclosure, the first connector and the second connector may be pogo pins. A pogo pin may refer to a cylindrical pin in which a conductive pin is connected to a spring inserted therein. When a male pogo pin and a female pogo pin are engaged with each other, their respective conductive pins make contact, thereby establishing an electrical connection. However, this is only an example, and the first connector and the second connector are not limited to pogo pins, and may be other types of connectors that serve to connect two conductors.

In an embodiment of the disclosure, when the first connector and the second connector are connected to each other, the electronic device 100 may supply power to the IR touch sensor 350 mounted on the holder 310 via the first connector and the second connector. In an embodiment of the disclosure, in response to power being supplied from the electronic device 100, the IR touch sensor 350 provided on the holder 310 may be activated when being plugged into the electronic device 100 and turned on.

In an embodiment of the disclosure, the IR touch sensor 350 may include an IR transmitting device 351 and an IR receiving device 355.

In an embodiment of the disclosure, the IR transmitting device 351 included in the IR touch sensor 350 may be provided in the front holder 311. In an embodiment of the disclosure, the IR transmitting device 351 included in the IR touch sensor 350 may include an IR light-emitting diode (LED). In an embodiment of the disclosure, the IR transmitting device 351 included in the IR touch sensor 350 may be located in a region of the front holder 311 to project an IR signal toward the projection surface via the IR LED. For example, as illustrated in FIG. 3, the IR transmitting device 351 included in the IR touch sensor 350 may be located in a central portion of a bottom end of the front holder 311, but is not limited thereto, and the position of the IR transmitting device 351 included in the IR touch sensor 350 may be variously modified within a range that would be obvious to those skilled in the art.

In an embodiment of the disclosure, the IR receiving device 355 included in the IR touch sensor 350 may include an IR camera. In an embodiment of the disclosure, the IR camera may obtain a reflected IR signal by photographing the projection surface 200. When a user touches the projection surface 200 or moves a hand, the IR camera may collect reflected IR signals from a finger or the hand to analyze the position and/or movement of the finger or the hand.

In an embodiment of the disclosure, the IR receiving device 355 included in the IR touch sensor 350 may be fixed to a region of the front holder 311. For example, as illustrated in FIG. 3, the IR receiving device 355 may be located in a central portion of a top end of the front holder 311 and fixed to be tilted toward the projection surface 200. However, the disclosure is not limited thereto, and the position, tilt, or the like of the IR receiving device 355 may be variously modified within a range that would be obvious to those skilled in the art.

In an embodiment of the disclosure, based on the orientation of the electronic device 100 being the floor-projection orientation, the electronic device 100 may identify whether the IR touch sensor 350 used for IR touch interaction is activated, and control ON/OFF of the ToF sensor 133 according to whether the IR touch sensor 350 is activated.

In an embodiment of the disclosure, when the IR touch sensor 350 is turned on and in the activated state, the electronic device 100 may continuously control the ToF sensor 133 to be turned off so as to prevent an IR signal emitted from the ToF sensor 133 from affecting the IR touch sensor 350 used for performing the IR touch interaction function.

In an embodiment of the disclosure, when the ToF sensor 133 is turned off, the electronic device 100 cannot obtain a distance between the electronic device 100 and the projection surface via the ToF sensor 133, and thus cannot perform auto keystone correction.

In an embodiment of the disclosure, when the ToF sensor 133 is turned off, the electronic device 100 may perform keystone correction by using keystone correction information pre-stored in the electronic device 100, so as to prevent a screen from being distorted when the IR touch interaction function is performed.

In an embodiment of the disclosure, when the electronic device 100 is in the floor-projection orientation and connected to the IR touch sensor 350 via the holder 310, and the IR touch sensor 350 is mounted and fixed to a region of the holder 310, the height of the holder 310 may have a fixed value. As a result, the distance or angle between the projection unit 120 included in the electronic device 100 and a floor surface (e.g., the projection surface 200), may have a fixed value.

In an embodiment of the disclosure, the manufacturer of the electronic device 100 may generate keystone correction information in advance by using a height of the holder 310, a distance or an angle between the projection unit 120 and the projection surface 200, and the like.

In an embodiment of the disclosure, the keystone correction information may include at least one of coordinate values of a keystone screen or distance values for focus adjustment.

The manufacturer may store the generated keystone correction information in non-volatile memory within the electronic device 100.

In an embodiment of the disclosure, in response to the orientation of the electronic device 100 being the floor-projection orientation and the ToF sensor 133 being controlled to be turned off, the electronic device 100 may obtain the keystone correction information pre-stored in the memory.

In an embodiment of the disclosure, the electronic device 100 may adjust the projection surface 200 such that four coordinate values of the projection surface 200 correspond to the coordinate values of the keystone screen obtained from the memory. In addition, the electronic device 100 may adjust a focus by using a distance value obtained from the memory, and project an image.

In an embodiment of the disclosure, when the electronic device 100 is in the floor-projection orientation, the electronic device 100 may receive a keystone correction command signal via a user input. When the floor surface differs from the surface for which the keystone correction information pre-stored in the memory was generated (e.g., when the floor surface is uneven or has steps), the user may cause the electronic device 100 to perform keystone correction based on data obtained via the ToF sensor 133 such that the keystone correction is performed more accurately.

In an embodiment of the disclosure, when the electronic device 100 receives a keystone correction command signal via a user input while in the floor-projection orientation, the electronic device 100 may output information indicating a suspension of touch recognition. Via the information indicating the suspension of touch recognition, the user may be informed that the electronic device 100 is not currently performing the touch recognition function.

In addition, when the electronic device 100 receives a keystone correction command signal while in the floor-projection orientation, the electronic device 100 may activate the ToF sensor 133 and deactivate the IR touch sensor 350.

In an embodiment of the disclosure, in response to a keystone correction command signal according to a user input, the electronic device 100 may activate the ToF sensor 133 to measure distance information between the electronic device 100 and the projection surface 200. The electronic device 100 may obtain a tilt of the projection surface 200 by using the distance information, and perform keystone correction and/or focus adjustment for correcting image distortion or focus based on the tilt of the projection surface 200.

In an embodiment of the disclosure, after performing keystone correction according to the keystone correction command signal from the user, the electronic device 100 may change the ToF sensor 133 to the deactivated state and change the IR touch sensor 350 to the activated state. In addition, in an embodiment of the disclosure, after performing keystone correction, the electronic device 100 may output information indicating that touch recognition is possible. In an embodiment of the disclosure, the electronic device 100 may perform the IR touch interaction operation by using the projection surface for which the keystone correction has been performed.

In an embodiment of the disclosure, when the orientation of the electronic device 100 is the floor-projection orientation but the IR touch sensor 350 is deactivated, the electronic device 100 may switch the ToF sensor 133 back to the activated state. For example, when the IR touch sensor 350 remains in the deactivated state even after a certain time period has elapsed after the orientation of the electronic device 100 has changed to the floor-projection orientation, the electronic device 100 may determine that the user has no intention of performing the IR touch interaction operation, and change the ToF sensor 133, which is in the deactivated state, to the activated state.

Based on the ToF sensor 133 being activated, the electronic device 100 may obtain a distance between the electronic device 100 and the projection surface 200 by using the ToF sensor 133, and perform auto keystone correction based on the distance. In addition, the electronic device 100 may project a projection image on the projection surface 200 for which the auto keystone correction has been performed.

As such, according to an embodiment of the disclosure, the electronic device 100 may identify whether it is in the floor-projection orientation by using a rotation angle obtained via the acceleration sensor, and when it is in the floor-projection orientation, deactivate the ToF sensor 133.

In addition, when the electronic device 100 is in the floor-projection orientation, the electronic device 100 may identify whether the IR touch sensor 350 is activated, and determine whether to continue to keep the ToF sensor 133 deactivated or activated, according to whether the IR touch sensor 350 is activated.

According to an embodiment of the disclosure, in the floor-projection orientation, when the IR touch sensor 350 is activated, the electronic device 100 may continuously maintain the ToF sensor 133 in the deactivated state so as to prevent the IR touch sensor 350 from malfunctioning due to the ToF sensor 133.

According to an embodiment of the disclosure, when the electronic device 100 maintains the ToF sensor 133 in the deactivated state, the electronic device 100 may adjust the screen such that the screen is not distorted when the IR touch interaction function is performed, by performing keystone correction by using pre-stored keystone correction information.

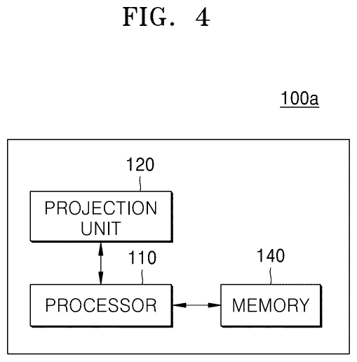

FIG. 4 is an example block diagram of an electronic device according to an embodiment of the disclosure.

An electronic device 100a of FIG. 4 may be an example of the electronic device 100 of FIG. 1 to FIG. 3.

Referring to FIG. 4, the electronic device 100a may include a processor 110, the projection unit 120, and memory 140.

The projection unit 120 according to an embodiment of the disclosure may project light for expressing an image to the outside. In an embodiment of the disclosure, the projection unit 120 may include projection circuitry. The projection unit 120 may include various components such as a light source, a projection lens, or a reflector. The projection unit 120 may include various types of light sources. For example, the projection unit 120 may include, as a light source, at least one of a lamp, an LED, or a laser.

The projection unit 120 may project an image by using various projection methods (e.g., a cathode-ray tube (CRT) method, a liquid-crystal display (LCD) method, a digital light processing (DLP) method, or a laser method).

The projection unit 120 may output an image with a 4:3 aspect ratio, a 5:4 aspect ratio, or a wide 16:9 aspect ratio depending on the use of the electronic device 100a or a user's settings, and may output an image with various resolutions, such as WVGA (854*480), SVGA (800*600), XGA (1024*768), WXGA (1180*720), WXGA (1180*800), SXGA (1180*1024), UXGA (1600*1100), or full HD (1920*1080), depending on the aspect ratio.

The projection unit 120 may perform various functions for adjusting an output image under control of the processor 110. The projection unit 120 may analyze a surrounding environment and a projection environment, to perform a zoom function, a keystone correction function, a focus adjustment function, and the like. The projection unit 120 may automatically perform a zoom function, a keystone correction function, a focus adjustment function, and the like, based on a rotation angle of the electronic device 100a with respect to the direction of gravity obtained via the acceleration sensor, a distance between the electronic device 100a and the projection surface 200 detected via the ToF sensor, information about a space where the electronic device 100a is currently located, and the like.

The memory 140 according to an embodiment of the disclosure may store various pieces of data, programs, or applications for driving and controlling the electronic device 100a. The memory 140 may also store predefined operation rules or an artificial intelligence (AI) model. The memory 140 may store at least one program executable by the processor 110. A program stored in the memory 140 may include one or more instructions. Programs, one or more instructions, or applications stored in the memory 140 may be executed by the processor 110.

The memory 140 may store data input to or output from the electronic device 100a.

The memory 140 may include at least one of a flash memory-type storage medium, a hard disk-type storage medium, a multimedia card micro-type storage medium, card-type memory (e.g., Secure Digital (SD) or extreme Digital (XD) memory), random-access memory (RAM), static RAM (SRAM), read-only memory (ROM), electrically erasable programmable ROM (EEPROM), programmable ROM (PROM), magnetic memory, a magnetic disc, or an optical disc.

In an embodiment of the disclosure, the memory 140 may store one or more instructions for obtaining a rotation state of the electronic device 100a. In an embodiment of the disclosure, rotation state information may include a pitch angle and a roll angle, which are rotation angles of the electronic device 100a with respect to the direction of gravity.

In an embodiment of the disclosure, the memory 140 may store one or more instructions for identifying an orientation of the electronic device 100a by using a pitch angle and a roll angle.

In an embodiment of the disclosure, the memory 140 may store one or more instructions for identifying whether the electronic device 100a is in a wall-projection orientation or a floor-projection orientation, by determining whether a pitch angle and a roll angle are within reference angle ranges.

In an embodiment of the disclosure, the memory 140 may store one or more instructions for, based on the electronic device 100a being in the floor-projection orientation, deactivating the ToF sensor.

In an embodiment of the disclosure, the memory 140 may store one or more instructions for, based on the electronic device 100a being in the floor-projection orientation, identifying whether the IR touch sensor is activated.

In an embodiment of the disclosure, the memory 140 may store one or more instructions for, when the electronic device 100a is in the floor-projection orientation and the IR touch sensor is activated, maintaining the ToF sensor in the deactivated state.

In an embodiment of the disclosure, the memory 140 may store one or more instructions for, when the electronic device 100a is in the floor-projection orientation and the IR touch sensor is deactivated, switching the ToF sensor to the activated state.

In an embodiment of the disclosure, the memory 140 may store one or more instructions for, based on the electronic device 100a being in the floor-projection orientation and the ToF sensor being in the deactivated state, obtaining keystone correction information pre-stored in the memory 140.

In an embodiment of the disclosure, keystone correction information that is used to perform keystone correction when the electronic device 100a is in the floor-projection orientation and the ToF sensor is in the deactivated state may be pre-stored in the memory 140.

In an embodiment of the disclosure, the keystone correction information may include coordinate values (x1, y1), (x2, y2), (x3, y3), and (x4, y4) corresponding to four corners of a keystone screen. In addition, the keystone correction information may further include distance values for focus adjustment.

In an embodiment of the disclosure, the keystone correction information may be stored in non-volatile memory such as EEPROM or flash memory.

In an embodiment of the disclosure, the keystone correction information pre-stored in the memory 140 may include at least one of coordinate values of a keystone screen or distance values for focus adjustment.

In an embodiment of the disclosure, the memory 140 may store one or more instructions for performing keystone correction by using pre-stored keystone correction information.

In an embodiment of the disclosure, the memory 140 may store one or more instructions for, when the electronic device 100a receives a keystone correction command signal while in the floor-projection orientation, deactivating the IR touch sensor and activating the ToF sensor.

In an embodiment of the disclosure, the memory 140 may store one or more instructions for, in response to receiving a keystone correction command signal when the electronic device 100a is in the floor-projection orientation, outputting information indicating a suspension of touch recognition.

In an embodiment of the disclosure, the memory 140 may store one or more instructions for performing keystone correction based on information obtained via the ToF sensor, according to a keystone correction command signal when the electronic device 100a is in the floor-projection orientation.

In an embodiment of the disclosure, the memory 140 may store one or more instructions for activating the IR touch sensor and deactivating the ToF sensor, after keystone correction is performed based on information obtained via the ToF sensor, while the electronic device 100a is in the floor-projection orientation.

In an embodiment of the disclosure, the memory 140 may store one or more instructions for outputting information indicating that touch recognition is possible, after keystone correction is performed based on information obtained via the ToF sensor, while the electronic device 100a is in the floor-projection orientation.

In an embodiment of the disclosure, the memory 140 may store one or more instructions for, based on the electronic device 100a being in the wall-projection orientation, activating the ToF sensor.

In an embodiment of the disclosure, the memory 140 may store one or more instructions for, based on the electronic device 100a being in the wall-projection orientation and the ToF sensor being turned on, performing auto keystone correction by using a rotation angle based on raw data obtained via the ToF sensor.

In an embodiment of the disclosure, the memory 140 may store one or more instructions for, based on the electronic device 100a being in the wall-projection orientation, preventing an IR touch function from being performed, regardless of whether the IR touch sensor is activated. The processor 110 according to an embodiment of the disclosure performs functions of controlling the overall operation of the electronic device 100a and signal flows among internal components of the electronic device 100a, and processing data.

The processor 110 may include processing circuitry. The processor 110 may include a single core, dual cores, triple cores, quad cores, or cores corresponding to a multiple thereof. The processor 110 may be a single processor or may include a plurality of processors. For example, the processor 110 may include a main processor and a sub-processor.

In an embodiment of the disclosure, the processor 110 may include at least one of a central processing unit (CPU), a graphics processing unit (GPU), or a video processing unit (VPU). In an embodiment of the disclosure, the processor 110 may be implemented as a system-on-chip (SoC) that integrates at least one of a CPU, a GPU, or a VPU. Alternatively, the processor 110 may further include a neural processing unit (NPU).

The processor 110 according to an embodiment of the disclosure may control the overall operation of the electronic device 100a. The processor 110 may execute one or more instructions stored in the memory 140 to control the electronic device 100a to function.

In an embodiment of the disclosure, at least one processor 110 may execute one or more instructions stored in the memory 140, individually or collectively to control the operation of the electronic device 100a.

In an embodiment of the disclosure, the at least one processor 110 may obtain rotation state information about the electronic device 100a.

In an embodiment of the disclosure, the rotation state information may include a rotation angle of the electronic device 100a with respect to the direction of gravity.

In an embodiment of the disclosure, the at least one processor 110 may obtain rotation angles of the electronic device 100a with respect to the direction of gravity based on raw data obtained via the acceleration sensor. In an embodiment of the disclosure, the rotation angles of the electronic device 100a with respect to the direction of gravity may include a pitch angle and a roll angle.

In an embodiment of the disclosure, the at least one processor 110 may identify whether the orientation of the electronic device 100a is the wall-projection orientation or the floor-projection orientation, by determining whether the pitch angle and the roll angle are within reference angle ranges.

In an embodiment of the disclosure, based on the orientation of the electronic device 100a being the floor-projection orientation, the at least one processor 110 may deactivate the ToF sensor.

In an embodiment of the disclosure, based on the orientation of the electronic device 100a being the floor-projection orientation, the at least one processor 110 may identify whether the IR touch sensor is activated.

In an embodiment of the disclosure, based on the orientation of the electronic device 100a being the floor-projection orientation, the at least one processor 110 may control ON/OFF of the ToF sensor according to whether the IR touch sensor is activated.

In an embodiment of the disclosure, when the orientation of the electronic device 100a is the floor-projection orientation and the IR touch sensor is activated, the at least one processor 110 may maintain the ToF sensor in the deactivated state.

In an embodiment of the disclosure, when the orientation of the electronic device 100a is the floor-projection orientation and the IR touch sensor is deactivated, the at least one processor 110 may switch the ToF sensor to the activated state.

In an embodiment of the disclosure, in response to the orientation of the electronic device 100a being the floor-projection orientation and the ToF sensor being in the deactivated state, the at least one processor 110 may obtain keystone correction information pre-stored in the memory 140.

In an embodiment of the disclosure, the at least one processor 110 may perform keystone correction by using the keystone correction information obtained from the memory 140.

In an embodiment of the disclosure, when the orientation of the electronic device 100a is the floor-projection orientation, the at least one processor 110 may receive a keystone correction command from the user, separately from performing keystone correction with keystone correction information obtained from the memory 140.

In an embodiment of the disclosure, in response to receiving a keystone correction command signal from the user, the at least one processor 110 may output information indicating a suspension of touch recognition.

In an embodiment of the disclosure, when receiving a keystone correction command signal from the user while the orientation of the electronic device 100a is the floor-projection orientation, the at least one processor 110 may deactivate the IR touch sensor and activate the ToF sensor.

In an embodiment of the disclosure, the at least one processor 110 may obtain raw data via the ToF sensor and perform keystone correction based on the raw data.

In an embodiment of the disclosure, after performing the keystone correction according to the keystone correction command signal from the user, the at least one processor 110 may activate the IR touch sensor and deactivate the ToF sensor.

In an embodiment of the disclosure, after performing the keystone correction, the at least one processor 110 may output information indicating that touch recognition is possible.

In an embodiment of the disclosure, based on identifying that the orientation of the electronic device 100a is the wall-projection orientation by determining whether a pitch angle and a roll angle are within reference angle ranges, the at least one processor 110 may activate the ToF sensor.

In an embodiment of the disclosure, while the electronic device 100a is in the wall-projection orientation, the at least one processor 110 may obtain raw data by using the ToF sensor, and perform auto keystone correction based on the raw data.

In an embodiment of the disclosure, when the electronic device 100a is in the wall-projection orientation, the at least one processor 110 may prevent the IR touch function from being performed, regardless of whether the IR touch sensor is activated.

In an embodiment of the disclosure, the at least one processor 110 may control the ToF sensor 133 to be turned off when the IR touch sensor 350 is turned on.

In an embodiment of the disclosure, the at least one processor 110 may control the ToF sensor 133 to be turned on when the IR touch sensor 350 is turned off.

In an embodiment of the disclosure, in response to controlling the ToF sensor 133 to be turned off, the at least one processor 110 may obtain keystone correction information pre-stored in the memory 140.

In an embodiment of the disclosure, the at least one processor 110 may perform keystone correction by using the keystone correction information obtained from the memory 140.

In an embodiment of the disclosure, based on the orientation of the electronic device 100a not being a touch mode orientation, the at least one processor 110 may control the ToF sensor 133 to be turned on.

In an embodiment of the disclosure, based on the ToF sensor 133 being turned on, the at least one processor 110 may perform auto keystone correction by using a rotation angle based on raw data obtained via the ToF sensor 133 and the acceleration sensor 131.

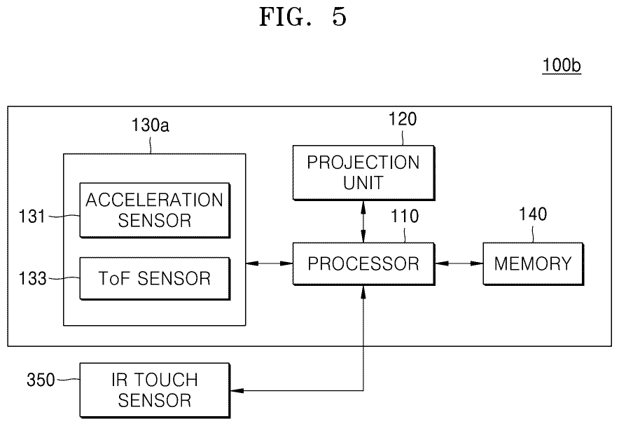

FIG. 5 is an example block diagram of an electronic device according to an embodiment of the disclosure.

An electronic device 100b of FIG. 5 may be an example of the electronic devices 100 and 100a of FIGS. 1 to 4.

Referring to FIG. 5, the electronic device 100b may include the processor 110, the projection unit 120, a sensing unit 130a, and the memory 140.

In an embodiment of the disclosure, the electronic device 100b may include the sensing unit 130a.

The sensing unit 130a may include a first sensor and a second sensor.

For example, the first sensor may be the ToF sensor 133, and the second sensor may be the acceleration sensor 131.

In an embodiment of the disclosure, the ToF sensor 133 may obtain precise distance and depth information by measuring the time of flight of light. In an embodiment of the disclosure, the ToF sensor 133 may include a 3D ToF sensor. In an embodiment of the disclosure, the ToF sensor 133 may include an IR transmitting unit and an IR receiving unit. In an embodiment of the disclosure, the ToF sensor 133 may measure distance and depth information with respect to a projection surface via the IR transmitting unit and the IR receiving unit.

In an embodiment of the disclosure, the ToF sensor 133 may generate a depth map of a screen by emitting an IR signal to a plurality of points on a projection surface and measuring a time taken for a reflected signal to return. For example, the electronic device 100b may collect depth data by measuring distance data regarding four corner points (top left, top right, bottom left, and bottom right) of the screen by using the ToF sensor. The electronic device 100b may calculate a spatial position of the projection surface by comparing the measured depths of the respective points. The electronic device 100b may mathematically define a plane composed of four points to obtain a normal vector of the plane, and calculate a degree of screen distortion based on the normal vector.

In an embodiment of the disclosure, the acceleration sensor 131, which is the second sensor, may obtain raw data for orientation estimation of the electronic device 100b. In an embodiment of the disclosure, the processor 110 may estimate a roll angle and a pitch angle, which are rotation angles of the electronic device 100b with respect to the direction of gravity, from the raw data obtained by the acceleration sensor 131.

In an embodiment of the disclosure, the electronic device 100b may perform an IR touch interaction operation by using a third sensor. In the disclosure, the third sensor may be the IR touch sensor 350.

In one example, the IR touch sensor 350 may be separate from the electronic device 100b. In an embodiment of the disclosure, the IR touch sensor 350 may be mounted on a holder, which may be detachably coupled to the electronic device 100b, to be connected to the electronic device 100b via the holder.

In an embodiment of the disclosure, the electronic device 100b and the holder may be connected to each other via a connector. In an embodiment of the disclosure, the electronic device 100b may supply power to the IR touch sensor 350 via the connector to activate the IR touch sensor 350.

In an embodiment of the disclosure, when in the floor-projection orientation, the electronic device 100b may identify whether the IR touch sensor 350 is activated, and control ON/OFF of the ToF sensor 133 according to whether the IR touch sensor 350 is activated.

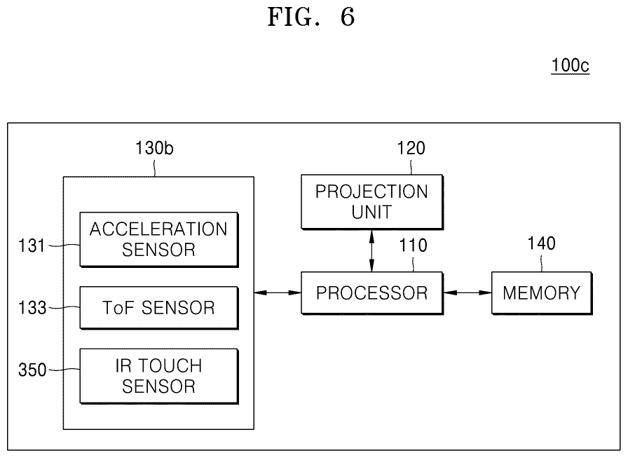

FIG. 6 is an example block diagram of an electronic device according to an embodiment of the disclosure.

Referring to FIG. 6, an electronic device 100c may include the processor 110, the projection unit 120, a sensing unit 130b, and the memory 140.

The electronic device 100c of FIG. 6 may perform the same operation as the electronic device 100b of FIG. 5, except that the configuration of the sensing unit 130b is different from that of the sensing unit 130a.

The sensing unit 130b according to an embodiment of the disclosure may include a first sensor, a second sensor, and a third sensor. In an embodiment of the disclosure, the first sensor may be the ToF sensor 133, the second sensor may be the acceleration sensor 131, and the third sensor may be the IR touch sensor 350.

Unlike the electronic device 100b illustrated in FIG. 5, the electronic device 100c illustrated in FIG. 6 may integrate the IR touch sensor 350.

In an embodiment of the disclosure, at least one processor 110 may obtain a pitch angle and a roll angle, which are rotation angles of the electronic device 100c, based on raw data obtained via the acceleration sensor 131, and identify whether the orientation of the electronic device 100c is the floor-projection orientation or the wall-projection orientation by determining whether the pitch angle and the roll angle are within reference angle ranges.

In an embodiment of the disclosure, based on the orientation of the electronic device 100c being the floor-projection orientation, the at least one processor 110 may deactivate the ToF sensor 133.

In an embodiment of the disclosure, based on the electronic device 100c being in the floor-projection orientation, the at least one processor 110 may identify whether the IR touch sensor 350 is activated.

For example, as in FIG. 6, in a case in which the IR touch sensor 350 may be mounted on the electronic device 100c, the IR touch sensor 350 may be changed to the activated state when the electronic device 100c is powered on. Alternatively, the IR touch sensor 350 may remain in the deactivated state even when the electronic device 100c is powered on, and then may be changed to the activated state according to a control command from a user.

In an embodiment of the disclosure, when the electronic device 100c is in the floor-projection orientation and the IR touch sensor 350 is in the activated state, the at least one processor 110 may maintain the ToF sensor 133 in the deactivated state such that the ToF sensor 133 does not operate.

In an embodiment of the disclosure, in response to deactivating the ToF sensor 133, the at least one processor 110 may obtain keystone correction information pre-stored in the memory 140 and perform keystone correction by using the keystone correction information.

In an embodiment of the disclosure, when the orientation of the electronic device 100c is the wall-projection orientation, the at least one processor 110 may control the ToF sensor 133 to be turned on to be in the activated state.

In an embodiment of the disclosure, when the orientation of the electronic device 100c is the wall-projection orientation, the at least one processor 110 may turn off the IR touch sensor 350. In an embodiment of the disclosure, when the orientation of the electronic device 100c is the wall-projection orientation, the at least one processor 110 may prevent the IR touch function from being performed, regardless of whether the IR touch sensor 350 is turned on or off.

In an embodiment of the disclosure, while the electronic device 100c is in the wall-projection orientation, the at least one processor 110 may obtain a distance between the electronic device 100c and a wall surface by using the ToF sensor 133, and perform auto keystone correction by using the distance.

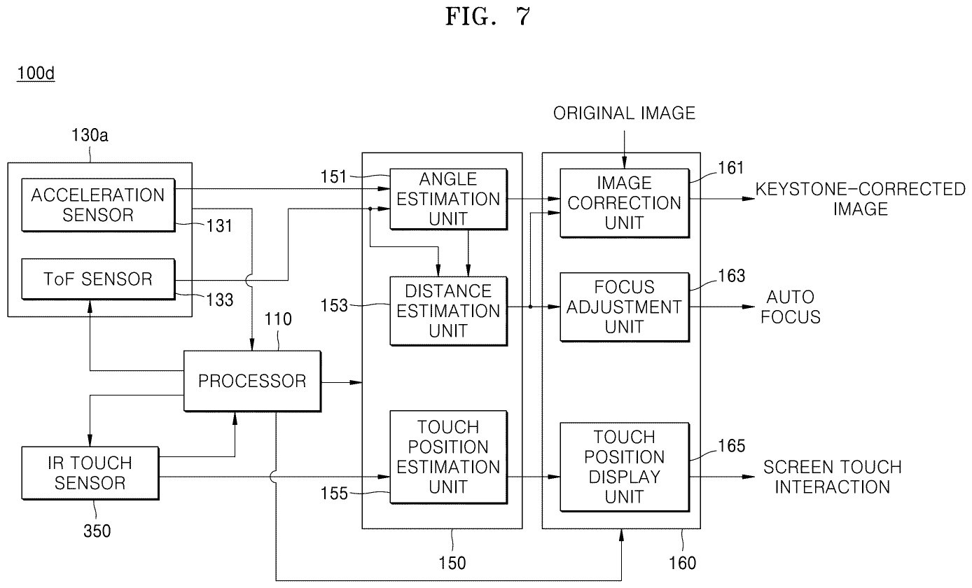

FIG. 7 is an example block diagram of an electronic device according to an embodiment of the disclosure.

An electronic device 100d of FIG. 7 may be an example of the electronic devices 100, 100a, 100b, and 100c of FIGS. 1 to 6. For various embodiments of the disclosure, although not explicitly illustrated in FIG. 7, the electronic device 100d may include one or more components of the electronic devices 100, 100a, 100b, and 100c of FIGS. 1 to 6.

In addition, because the sensing unit 130a included in the electronic device 100d illustrated in FIG. 7 performs the same function as the sensing unit 130a included in the electronic device 100b illustrated in FIG. 5, the same reference numeral is used for them.

Referring to FIG. 7, the electronic device 100d may include the processor 110, the sensing unit 130a, a sensor signal processing unit 150, and an image processing unit 160. In an embodiment of the disclosure, the electronic device 100d may operate while being connected to the IR touch sensor 350, which may be separate from the electronic device 100d.

As illustrated in FIG. 7, the sensor signal processing unit 150 and the image processing unit 160 may be separate from the processor 110. That is, as illustrated in FIG. 7, the sensor signal processing unit 150 and the image processing unit 160 may be modules that are included in the electronic device 100d separately from the processor 110 and operate under control of the processor 110. However, this is only an example, and the sensor signal processing unit 150 and the image processing unit 160 may be modules included in the processor 110, and the processor 110 may also perform the operations of the sensor signal processing unit 150 and the image processing unit 160.

In an embodiment of the disclosure, the sensor signal processing unit 150 and the image processing unit 160 may include suitable logic, circuitry, interfaces, and/or code that may be operated to provide the functions of processing sensor signals and processing images.

In an embodiment of the disclosure, the term ‘module’ may refer to a functional and structural combination of hardware for carrying out the technical spirit of the disclosure and software for driving the hardware. For example, the term ‘module’ may refer to a logical unit including certain code and a hardware resource for executing the code, and is not necessarily limited to physically connected code or one type of hardware.

The sensing unit 130a according to an embodiment of the disclosure may include the acceleration sensor 131 and the ToF sensor 133. In an embodiment of the disclosure, in FIG. 7, the IR touch sensor 350 may be separate from the electronic device 100d.

In an embodiment of the disclosure, the acceleration sensor 131 may be a 3-axis acceleration sensor. In a case in which the acceleration sensor 131 is a 3-axis acceleration sensor, the acceleration sensor 131 may obtain raw data by measuring gravitational acceleration values for the X-axis, the Y-axis, and the Z-axis, respectively.

In an embodiment of the disclosure, the ToF sensor 133 may emit an IR signal and measure a time taken for a reflected signal to return. In an embodiment of the disclosure, the ToF sensor 133 may measure a distance and a depth between the projection surface 200 and the electronic device 100d.

In an embodiment of the disclosure, the IR touch sensor 350 may project an IR signal via an IR LED, and collect a reflected IR signal from a user's finger or a tool (e.g., stylus) by using an IR camera, to analyze the position and/or movement of the finger.

The sensor signal processing unit 150 according to an embodiment of the disclosure may process raw data obtained from the sensing unit 130a.

In an embodiment of the disclosure, the sensor signal processing unit 150 may include an angle estimation unit 151, a distance estimation unit 153, and a touch position estimation unit 155.

In an embodiment of the disclosure, the angle estimation unit 151 may estimate an angle or an orientation of the electronic device 100d by performing signal processing by using raw data received from the sensing unit 130a. In an embodiment of the disclosure, the angle estimation unit 151 may estimate a roll angle and a pitch angle based on raw data received from the acceleration sensor 131.

In an embodiment of the disclosure, the distance estimation unit 153 may receive, from the ToF sensor 133, distances to a plurality of points on a projection surface, and calculate distance differences among the plurality of points on the projection surface.

In an embodiment of the disclosure, before estimating an orientation of the electronic device 100d or a distance to the projection surface, the angle estimation unit 151 and the distance estimation unit 153 may first remove noise from the raw data. For example, to remove noise included in the raw data, the angle estimation unit 151 and the distance estimation unit 153 may filter out and remove the noise included in the raw data by using a low-pass filter, a moving average, or the like.

In an embodiment of the disclosure, the angle estimation unit 151 and the distance estimation unit 153 may perform signal processing for noise filtering by using raw data that has been received from the sensing unit 130a for a certain period of time, or may filter out noise in real time simultaneously with receiving raw data from the sensing unit 130a.

In an embodiment of the disclosure, the angle estimation unit 151 and the distance estimation unit 153 may estimate an orientation of the electronic device 100d and a distance to a projection surface based on the noise-filtered raw data. However, this is only an example, and the angle estimation unit 151 may directly estimate an orientation of the electronic device 100d or estimate a distance to the projection surface based on the raw data without noise removal.

In an embodiment of the disclosure, the angle estimation unit 151 may calculate a roll angle φ and a pitch angle θ based on raw data received from the acceleration sensor 131, by using Equation 1 and Equation 2 below.

$$ϕ = {tan}^{- 1} ( \frac{{A}_{by}}{{A}_{bz}} ) \qquad [ Equation 1 ]$$

$$θ = {tan}^{- 1} ( \frac{{A}_{bx}}{\sqrt{{A}_{by}^{2} + {A}_{bz}^{2}}} ) \qquad [ Equation 2 ]$$

In Equation 1, A_{bx}, A_{by}, and A_{bz} denote x-, y-, and z-axis acceleration values of the acceleration sensor 131, respectively.

The image processing unit 160 according to an embodiment of the disclosure may perform image processing by using information received from the sensor signal processing unit 150.

In an embodiment of the disclosure, the image processing unit 160 may include an image correction unit 161, a focus adjustment unit 163, and a touch position display unit 165.

In an embodiment of the disclosure, the image correction unit 161 may perform keystone correction by using rotation angle and/or distance information received from the angle estimation unit 151 and the distance estimation unit 153.

In an embodiment of the disclosure, the image correction unit 161 may define initial coordinates of four vertices of a projection surface. In an embodiment of the disclosure, the image correction unit 161 may estimate a distorted rectangle by calculating transformed coordinates according to a rotation angle.

In an embodiment of the disclosure, the image correction unit 161 may obtain a projection matrix by using a pitch angle, a roll angle, a yaw angle, and a distance to the projection surface. The projection matrix may be modeled as a homography. The projection matrix may refer to a matrix that represents the relationship between points on a virtual plane without distortion and points on an actual projection surface, and parameters of the projection matrix may be obtained based on the pixel positions of four vertices of an image to be projected onto the projection surface and estimated pixel positions of four vertices on the projection surface when a keystone effect occurs.

In an embodiment of the disclosure, the image correction unit 161 may obtain a transformation matrix by using a pitch angle, a roll angle, a yaw angle, and a distance to the projection surface. In an embodiment of the disclosure, the image correction unit 161 may pre-warp, by using the projection matrix, the image to be projected onto the projection surface, to obtain a transformation matrix for outputting, onto the projection surface, an image that appears as rectangular as possible.

In an embodiment of the disclosure, the image correction unit 161 may obtain a keystone-corrected image by distorting an original image to transform a trapezoid into a rectangle for keystone correction, based on the projection matrix and the transformation matrix.

The focus adjustment unit 163 according to an embodiment of the disclosure may perform an auto focus function to allow the electronic device 100d to automatically focus a screen.

In an embodiment of the disclosure, the focus adjustment unit 163 may automatically adjust the position of a lens based on a distance to the projection surface obtained by using the ToF sensor 133. In an embodiment of the disclosure, the focus adjustment unit 163 may adjust the position of the lens forward and backward according to the distance, and check the sharpness of the screen. In an embodiment of the disclosure, when correction is needed, the focus adjustment unit 163 may re-adjust the focus to obtain an optimal focus.

In an embodiment of the disclosure, the touch position estimation unit 155 included in the sensor signal processing unit 150 may estimate a touch position by using a signal obtained by the IR touch sensor 350.

In an embodiment of the disclosure, the IR touch sensor 350 may include an IR transmitting device and an IR receiving device. The IR receiving device may be a type of IR camera. The IR camera may collect image data by photographing a projection surface and detecting IR light reflected from the projection surface. The IR camera may generate pixels, which constitute two-dimensional (2D) image data, by capturing an IR signal reflected by a finger or a stylus. The image contains differences in light brightness, and a position touched by the finger exhibits stronger reflection or a particular pattern.

In an embodiment of the disclosure, the touch position estimation unit 155 may receive an image from the IR touch sensor 350 and identify a continuous region having a particular brightness in the image. In an embodiment of the disclosure, the touch position estimation unit 155 may calculate coordinates (x, y) of a finger or a stylus by extracting pixels having a brightness greater than or equal to a particular brightness from the image, and calculating a center of the extracted region.

In an embodiment of the disclosure, the touch position display unit 165 included in the image processing unit 160 may visually display a touch point on the projection surface. In an embodiment of the disclosure, when a touch event occurs, the touch position display unit 165 may visually display a touch point by projecting a small circle or a cursor shape at the touched position. In an embodiment of the disclosure, the touch position display unit 165 may update the position of a touch pointer in real time when the user's finger or stylus moves.

In an embodiment of the disclosure, the touch position display unit 165 may provide a screen touch interaction to a user by converting touched coordinates (x, y) into pixel coordinates on a screen via a software rendering process, and generating and displaying a pointer or a highlight according to user interface (UI) elements of a projection image projected on a projection surface.

In an embodiment of the disclosure, when powered on, the electronic device 100d may perform booting and obtain raw data via the acceleration sensor 131.

In an embodiment of the disclosure, the angle estimation unit 151 may receive raw data from the acceleration sensor 131 and obtain a roll angle and a pitch angle based on the raw data.

In an embodiment of the disclosure, the processor 110 may identify whether the electronic device 100d is in the floor-projection orientation or the wall-projection orientation, by determining whether the roll angle and the pitch angle are within reference ranges.

In an embodiment of the disclosure, the processor 110 may maintain the ToF sensor 133 in an OFF state until it identifies whether the orientation of the electronic device 100d is the floor-projection orientation.

As illustrated in FIG. 7, in a case in which the IR touch sensor 350 is separate from the electronic device 100d, the IR touch sensor 350 may be in an OFF state until it is connected to the electronic device 100d.

Even when the IR touch sensor 350 is powered on and activated by receiving power from a power supply device other than the electronic device 100d, the electronic device 100d may determine that the IR touch sensor 350 is in an OFF state because the IR touch sensor 350 does not affect the operation of the electronic device 100d before being connected thereto.

In an embodiment of the disclosure, when the processor 110 determines that the electronic device 100d is in the wall-projection orientation, the processor 110 may activate the ToF sensor 133 by controlling the ToF sensor 133 to be turned on, and obtain distance or depth information with respect to the electronic device 100d by using raw data obtained from the ToF sensor 133. In an embodiment of the disclosure, the image correction unit 161 may perform auto keystone correction by using a rotation angle and a distance obtained via the acceleration sensor 131 and the ToF sensor 133, and the focus adjustment unit 163 may perform an auto focus operation by adjusting the position of a lens by using a distance value obtained via the ToF sensor 133.

In an embodiment of the disclosure, when the electronic device 100d is in the wall-projection orientation, the processor 110 may prevent the IR touch function from being performed, regardless of whether the IR touch sensor 350 is connected or activated. In an embodiment of the disclosure, when the processor 110 determines that the electronic device 100d is in the floor-projection orientation, the processor 110 may leave the ToF sensor 133 in the deactivated state.

In an embodiment of the disclosure, when the electronic device 100d is in the floor-projection orientation, the processor 110 may determine whether the IR touch sensor 350 is connected to the electronic device 100d and activated.

In an embodiment of the disclosure, in response to the IR touch sensor 350 being plugged into the electronic device 100d, the processor 110 may activate the IR touch sensor 350 by supplying power thereto.

In an embodiment of the disclosure, that the IR touch sensor 350 is activated may mean that the IR touch sensor 350 is powered on to be able to operate normally according to its function.

In an embodiment of the disclosure, in response to the electronic device 100d being in the floor-projection orientation and the IR touch sensor 350 being connected to the electronic device 100d to be in the activated state, the processor 110 may maintain the ToF sensor 133 in the deactivated state.

In an embodiment of the disclosure, there may be a case in which, after the electronic device 100d has booted, the orientation of the electronic device 100d may not the floor-projection orientation and may be then changed to the floor-projection orientation. In an embodiment of the disclosure, the processor 110 may monitor whether the orientation of the electronic device 100d has changed to the floor-projection orientation, based on a rotation angle of the electronic device 100d obtained as raw data by the angle estimation unit 151.

In an embodiment of the disclosure, when it is determined that the orientation of the electronic device 100d has changed to the floor-projection orientation, the processor 110 may leave the ToF sensor 133 in the deactivated state, determine whether the IR touch sensor 350 is connected to the electronic device 100d and activated, and based on determining that the IR touch sensor 350 is in the activated state, continue to deactivate the ToF sensor 133.

Thus, according to an embodiment of the disclosure, when the electronic device 100d is in the floor-projection orientation and the IR touch sensor 350 is activated, the processor 110 may deactivate the ToF sensor 133 to prevent it from emitting an IR signal, such that a touch detection operation is performed without error during an IR touch interaction operation.

In an embodiment of the disclosure, when the electronic device 100d is in the floor-projection orientation and the IR touch sensor 350 is in the activated state, the processor 110 cannot perform auto keystone correction and/or auto focus adjustment because it cannot use the ToF sensor 133.

In an embodiment of the disclosure, when the electronic device 100d is in the floor-projection orientation and the IR touch sensor 350 is in the activated state, the processor 110 may perform keystone correction by using keystone correction information pre-stored in memory, instead of obtaining and using data via the ToF sensor 133.

In an embodiment of the disclosure, the keystone correction information stored in the memory may include coordinate values of a keystone screen. In an embodiment of the disclosure, the keystone correction information may include, as target projection coordinates, coordinates (x1, y1), (x2, y2), (x3, y3), and (x4, y4) corresponding to four corners of a projection surface. In an embodiment of the disclosure, the image correction unit 161 may correct and output the shape of an image such that a projection image has coordinates corresponding to the given four corners.

In an embodiment of the disclosure, the image correction unit 161 may calculate a homography matrix based on original coordinates of an input image and the target projection coordinates, and output a corrected image by distorting and projecting the input image with transformed coordinates.

In an embodiment of the disclosure, the keystone correction information may include distance values for focus adjustment. In an embodiment of the disclosure, instead of using distance values obtained via the ToF sensor 133, the focus adjustment unit 163 may adjust the focus by adjusting the position of a lens by using distance values pre-stored in the memory.

In an embodiment of the disclosure, when in the floor-projection orientation, the electronic device 100d may receive a keystone correction command signal from a user. For example, when a floor surface is not horizontal or has steps, the user may command the electronic device 100d to perform keystone correction based on raw data obtained via the ToF sensor 133, instead of using information pre-stored in the memory.

In an embodiment of the disclosure, in response to receiving a keystone correction command signal via a user input, the electronic device 100d may output information indicating a suspension of touch recognition. For example, the electronic device 100d may output, as video data or audio data, content indicating that touch recognition on the projection surface is impossible.

In an embodiment of the disclosure, when the electronic device 100d receives a keystone correction command signal via a user input while in the floor-projection orientation, the electronic device 100d may activate the ToF sensor 133 and deactivate the IR touch sensor 350.

In an embodiment of the disclosure, in response to the keystone correction command signal, the electronic device 100d in the floor-projection orientation may activate the ToF sensor 133 to obtain distance information between the electronic device 100d and the projection surface by using the ToF sensor 133.

In an embodiment of the disclosure, the image correction unit 161 and the focus adjustment unit 163 may calculate a tilt of a projection surface by using distance information obtained via the ToF sensor 133, and perform keystone correction and/or focus adjustment based on the calculated tilt.

In an embodiment of the disclosure, after performing keystone correction according to a keystone correction command signal from a user, the electronic device 100d may change the ToF sensor 133 to the deactivated state and change the IR touch sensor 350 to the activated state, to perform the IR touch interaction operation.

In an embodiment of the disclosure, after performing keystone correction, the electronic device 100d may output information indicating that touch recognition is possible. For example, the electronic device 100d may output, as video data or audio data, content indicating that touch recognition on the projection surface is possible.

In an embodiment of the disclosure, when the electronic device 100d is in the floor-projection orientation but the IR touch sensor 350 is not in the activated state, the processor 110 may control the ToF sensor 133 to be turned on, obtain raw data via the ToF sensor 133, and perform auto keystone correction based on the raw data.

In an embodiment of the disclosure, the focus adjustment unit 163 may perform an auto focus operation by adjusting the position of a lens by using distance values obtained via the ToF sensor 133.

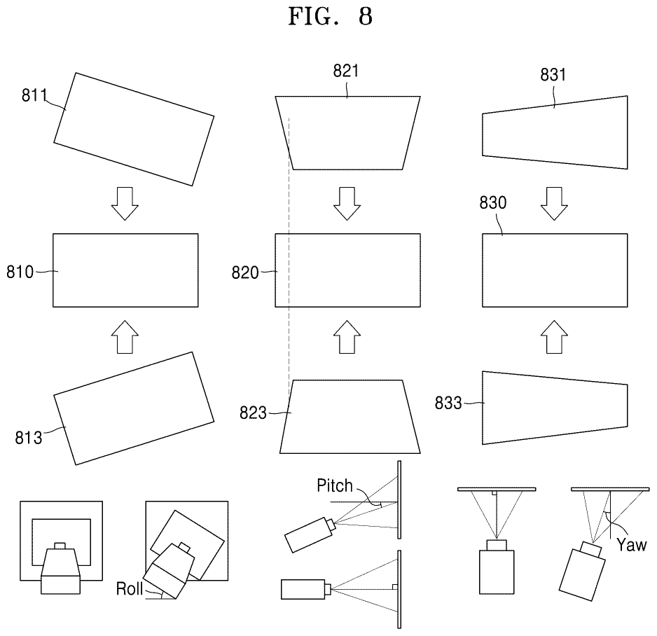

FIG. 8 is an example diagram illustrating keystone effects corresponding to rotation angles, according to an embodiment of the disclosure

As illustrated in FIG. 1, in a state in which a pitch angle θ, a roll angle φ, and a yaw angle ψ are defined, when the electronic device projects an original image while the tilt of the electronic device is in a normal state, an image without a keystone effect may be displayed on a projection surface. In an embodiment of the disclosure, the normal state of the tilt may refer to the pitch angle θ, the roll angle φ, and the yaw angle ψ being 0 or are less than or equal to reference range values, and a rotation angle between the electronic device and the projection surface, an angle at which the electronic device is tilted, and the like being within reference error ranges.

Referring to FIG. 8, when the electronic device is tilted in the X-axis direction such that the roll angle deviates from an error range, an image projected onto a projection surface may appear in a shape 811 tilted to the right or a shape 813 tilted to the left, according to the direction of the tilt.

In an embodiment of the disclosure, the electronic device may rotate the image in a direction opposite to the direction of change of the roll angle such that an undistorted image 810 is displayed on the projection surface.

When the electronic device is tilted in the Y-axis direction such that the pitch angle differs from a reference value (e.g., 0), an image projected onto the projection surface may appear in a trapezoidal shape 821 or 823 according to the direction of the tilt.

In an embodiment of the disclosure, the electronic device may perform correction to increase the length of the upper base or increase the length of the lower base, such that an undistorted image 820 is displayed on the projection surface.

When the electronic device is tilted in the Z-axis direction such that the yaw angle differs from a reference value (e.g., 0), an image projected onto the projection surface may appear in a trapezoidal shape 831 or 833 with a left or right side shorter than the other according to the direction of the tilt.

In an embodiment of the disclosure, the electronic device may perform correction to increase the length of the left side or increase the length of the right side, such that an undistorted image 830 is displayed on the projection surface.

In an embodiment of the disclosure, when the electronic device is in the floor-projection orientation and the ToF sensor is turned off, the electronic device may obtain keystone correction information from the memory to perform keystone correction, instead of performing auto keystone correction.

In an embodiment of the disclosure, the electronic device may distort and project an input image by using a perspective transformation (e.g., homography transformation). In an embodiment of the disclosure, the electronic device may set corners of a screen based on coordinate values included in keystone correction information, and project an image by correcting an input image such that given coordinates correspond to the correct corners of the projection image.

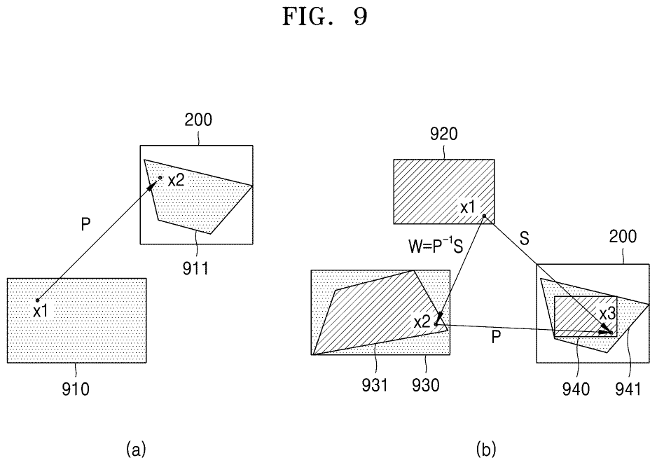

FIG. 9 is an example diagram illustrating image distortion due to a keystone effect, and an effect of keystone correction, according to an embodiment of the disclosure.

(a) of FIG. 9 is a diagram illustrating that an image is distorted by a keystone effect.

Referring to (a) of FIG. 9, when the electronic device projects an original image frame 910 having a rectangular shape, a distorted image frame 911 may be displayed on the projection surface 200 due to a keystone effect. A pixel x1 in the original image frame 910 may be displayed at a position x2 in the distorted image frame 911 on the projection surface 200, which is determined by a projection matrix.

(b) of FIG. 9 is a diagram illustrating a case in which image processing is performed through keystone correction.

According to an embodiment of the disclosure, the electronic device may convert an original image 920 into a corrected image 931 to correct a keystone effect.

In an embodiment of the disclosure, the electronic device may control the projection unit to project an image frame 930 including the corrected image 931. Accordingly, even when a keystone effect occurs on the projection surface 200 and the image frame 930 is thus distorted, the corrected image 931 may be represented as a rectangular projection image 940. The position of one pixel x1 in the original image 920 may belocated at a point x2 in the corrected image 931 by a projection matrix P and a scaling matrix S, and may be located at a point x3 in the image 940 displayed on the projection surface 200.

In an embodiment of the disclosure, the electronic device may identify whether an image to be actually displayed is within a preset region of the projection surface 200, by comparing coordinates of four vertices of an image to be displayed on the projection surface 200 with coordinates of four vertices of an image displayed on the projection surface 200 at the same distance in a normal state, that is, in a state in which the pitch angle, the roll angle, and the yaw angle are all 0 or are fixed to reference values.

When the image projected on the projection surface 200 is out of the preset region within the projection surface 200, the electronic device may control the size of the keystone-corrected image to project the image within the preset region. For example, the preset region may be a region within the size range of the projection surface 200.

When the projected image is located within the preset region, the electronic device may set a scale parameter such that the size of the image is maximized within the preset range. In some cases, the electronic device may also reduce the size of the image by adjusting the scale parameter.

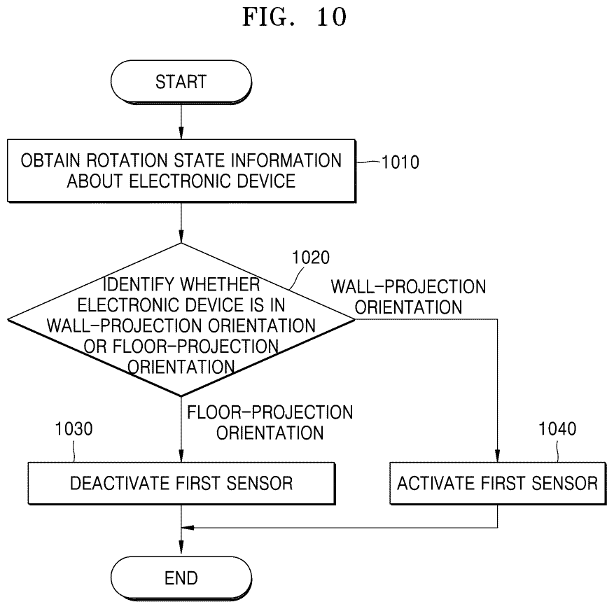

FIG. 10 is an example flowchart of an operating method of an electronic device, according to an embodiment of the disclosure.

Referring to FIG. 10, the electronic device may obtain rotation state information about the electronic device (operation 1010).

In an embodiment of the disclosure, the electronic device may identify whether the electronic device is in the wall-projection orientation or the floor-projection orientation (operation 1020).

In an embodiment of the disclosure, the electronic device may identify whether the electronic device is in the wall-projection orientation or the floor-projection orientation, by using the rotation state information about the electronic device.

In an embodiment of the disclosure, the electronic device may identify whether the orientation of the electronic device is the floor-projection orientation or the wall-projection orientation, by obtaining a pitch angle and a roll angle, which are rotation angles of the electronic device with respect to the direction of gravity, based on raw data obtained via an acceleration sensor, and identifying whether the pitch angle and the roll angle are within reference angle ranges.

For example, assuming that a pitch angle θ, a roll angle φ, and a yaw angle ψ are 0 degrees when an image projected by the electronic device is parallel to a wall surface as illustrated in FIG. 1, the orientation of the electronic device in a state in which the roll angle and the yaw angle are 0 degrees and the pitch angle is changed to 90 degrees may be defined as the floor-projection orientation.

In an embodiment of the disclosure, when the electronic device determines that the orientation of the electronic device is the floor-projection orientation, the electronic device may deactivate a first sensor (operation 1030). In an embodiment of the disclosure, the first sensor may be a ToF sensor.

In an embodiment of the disclosure, when the orientation of the electronic device is the wall-projection orientation, the electronic device may activate the first sensor (operation 1040). In an embodiment of the disclosure, the electronic device may perform keystone correction based on data obtained by using the first sensor.

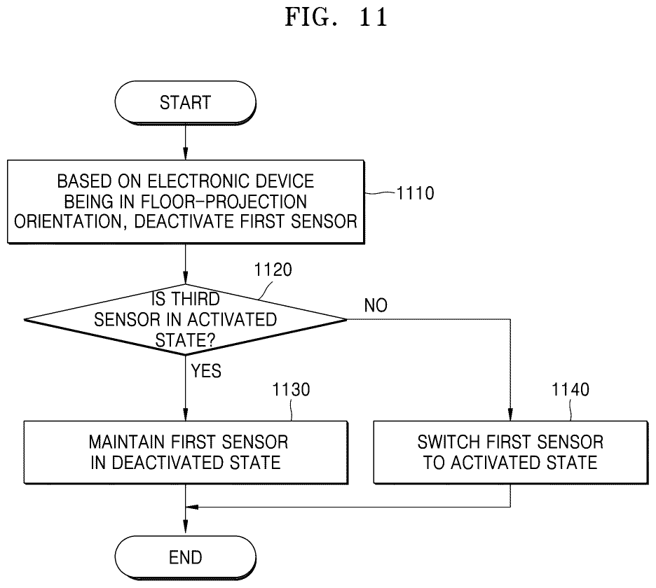

FIG. 11 illustrates an example operating method of an electronic device, according to an embodiment of the disclosure.

In an embodiment of the disclosure, based on the electronic device being in the floor-projection orientation, the electronic device may deactivate a first sensor (operation 1110).

In an embodiment of the disclosure, the electronic device may identify whether a third sensor is in an activated state (operation 1120). In an embodiment of the disclosure, the third sensor may be an IR touch sensor.

In an embodiment of the disclosure, in a case in which the third sensor is integrally provided in the electronic device, the electronic device may, after booting, maintain both a first sensor and a second sensor in an OFF state. Subsequently, when the electronic device determines that the orientation of the electronic device is the floor-projection orientation, the electronic device may deactivate the first sensor and control the third sensor to be automatically activated. Alternatively, when a user instructs, via a control device or the like, the electronic device to perform an IR touch interaction operation, the electronic device may cause an IR touch sensor, which is the third sensor, to be activated, by controlling the IR touch sensor to be turned on.

In an embodiment of the disclosure, in a case in which the third sensor is not integrated into the electronic device, the electronic device may be coupled to a holder in which the third sensor is provided, to be connected to the third sensor, and then activate the third sensor.

In an embodiment of the disclosure, the electronic device and the holder may be connected to each other via a connector. In an embodiment of the disclosure, the connector for the electronic device and the holder may include a pogo pin. The electronic device and the holder may be electrically connected to each other by conductive pins included in pogo pins being engaged with and contacting each other.

When the user connects the holder to the electronic device such that they are connected to each other via the connector, the electronic device may activate the third sensor by supplying power to the third sensor mounted on the holder via the connector.

In an embodiment of the disclosure, when the electronic device is in the floor-projection orientation and the third sensor is in an activated state, the electronic device may continue to maintain the first sensor in a deactivated state (operation 1130).

In an embodiment of the disclosure, when the third sensor is not in an activated state, the electronic device may switch the first sensor to an activated state (operation 1140).

An electronic device and an operating method thereof according to some embodiments of the disclosure may be implemented as a recording medium including computer-executable instructions such as a computer-executable program module.

A computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer readable instructions, data structures, program modules or other data. The communication media typically include computer-readable instructions, data structures, program modules, other data of a modulated data signal, or other transmission mechanisms, and examples thereof include an arbitrary information transmission medium.

In addition, an electronic device and an operating method thereof according to an embodiment of the disclosure may be implemented as a computer program product including a computer-readable recording medium/storage medium having recorded thereon a program for implementing the operating method of the electronic device, the operating method including obtaining rotation state information about the electronic device, identifying, by using the rotation state information about the electronic device, whether the electronic device is in a wall-projection orientation or a floor-projection orientation, deactivating, based on the electronic device being in the floor-projection orientation, a first sensor, and activating, based on the electronic device being in the wall-projection orientation, the first sensor.

A machine-readable storage medium may be provided in the form of a non-transitory storage medium. Here, the term ‘non-transitory storage medium’ may refer to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to various embodiments of the disclosure may be included in a computer program product and then provided. The computer program product may be traded as a commodity between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

What is claimed is:

1. An electronic device comprising:
a projection unit comprising projection circuitry;
at least one processor comprising processing circuitry; and
memory storing instructions that, when executed by the at least one processor individually or collectively, cause the electronic device to:
obtain rotation state information about the electronic device,
identify, by using the rotation state information about the electronic device, whether the electronic device is in a wall-projection orientation or a floor-projection orientation,
deactivate, based on the electronic device being in the floor-projection orientation, a first sensor, and
activate, based on the electronic device being in the wall-projection orientation, the first sensor.

2. The electronic device of claim 1, wherein the floor-projection orientation is an orientation of the electronic device when a projection surface is horizontal to a ground surface, and
wherein the wall-projection orientation is an orientation of the electronic device when the projection surface is perpendicular to the ground surface.

3. The electronic device of claim 1, wherein the instructions, when executed by the at least one processor individually or collectively, further cause the electronic device to, under control of the at least one processor,
obtain the rotation state information, based on raw data obtained via a second sensor, wherein the rotation state information comprises a pitch angle and a roll angle, the pitch angle and the roll angle being rotation angles of the electronic device with respect to a direction of gravity, and
identify whether the electronic device is in the wall-projection orientation or the floor-projection orientation, by identifying whether the pitch angle and the roll angle are within reference angle ranges, and
wherein the second sensor is an acceleration sensor.

4. The electronic device of claim 1, wherein the instructions, when executed by the at least one processor individually or collectively, further cause the electronic device to, under control of the at least one processor,
identify, based on the electronic device being in the floor-projection orientation, whether a third sensor is activated,
maintain, based on the third sensor being activated, the first sensor in a deactivated state, and
switch, based on the third sensor being deactivated, the first sensor to an activated state,
wherein the first sensor is a time-of-flight (ToF) sensor, and
wherein the third sensor is an infrared (IR) touch sensor.

5. The electronic device of claim 4, wherein the third sensor is mounted on a holder that is attachable to and detachable from the electronic device, and
wherein the third sensor, in response to the electronic device being attached to the holder, is connected to the electronic device and activated.

6. The electronic device of claim 1, wherein the instructions, when executed by the at least one processor individually or collectively, further cause the electronic device to, under control of the at least one processor,
obtain, in response to the electronic device being in the floor-projection orientation and the first sensor being in the deactivated state, keystone correction information pre-stored in the memory, and
perform keystone correction by using the obtained keystone correction information.

7. The electronic device of claim 6, wherein the keystone correction information comprises at least one of coordinate values of a keystone screen or a distance value for focus adjustment.

8. The electronic device of claim 4, wherein the instructions, when executed by the at least one processor individually or collectively, further cause the electronic device to, under control of the at least one processor,
based on receiving a keystone correction command signal via a user input when the electronic device is in the floor-projection orientation, deactivate the third sensor and activate the first sensor, and
perform keystone correction based on information obtained via the first sensor.

9. The electronic device of claim 8, wherein the instructions, when executed by the at least one processor individually or collectively, further cause the electronic device to, under control of the at least one processor,
after performing the keystone correction based on the information obtained via the first sensor, deactivate the first sensor and activate the third sensor.

10. The electronic device of claim 8, wherein the instructions, when executed by the at least one processor individually or collectively, further cause the electronic device to, under control of the at least one processor,
indicate, based on receiving the keystone correction command signal, a suspension of touch recognition, and
after performing the keystone correction, indicate that touch recognition is possible.

11. The electronic device of claim 4, wherein the instructions, when executed by the at least one processor individually or collectively, further cause the electronic device to, under control of the at least one processor,
based on the electronic device being in the wall-projection orientation, prevent an IR touch function from being performed regardless of whether the third sensor is activated.

12. An operating method of an electronic device, the operating method comprising:
obtaining rotation state information about the electronic device;
identifying, by using the rotation state information about the electronic device, whether the electronic device is in a wall-projection orientation or a floor-projection orientation;
deactivating, based on the electronic device being in the floor-projection orientation, a first sensor; and
activating, based on the electronic device being in the wall-projection orientation, the first sensor.

13. The operating method of claim 12, wherein obtaining of the rotation state information about the electronic device comprises obtaining the rotation state information about the electronic device based on raw data obtained via a second sensor,
wherein the rotation state information comprises a pitch angle and a roll angle, the pitch angle and the roll angle being rotation angles of the electronic device with respect to a direction of gravity,
wherein identifying of whether the electronic device is in the wall-projection orientation or the floor-projection orientation comprises identifying whether the electronic device is in the wall-projection orientation or the floor-projection orientation, by identifying whether the pitch angle and the roll angle are within reference angle ranges, and
wherein the second sensor is an acceleration sensor.

14. The operating method of claim 12, further comprising:
identifying, based on the electronic device being in the floor-projection orientation, whether a third sensor is activated;
maintaining, based on the third sensor being activated, the first sensor in a deactivated state; and
switching, based on the third sensor being deactivated, the first sensor to an activated state,
wherein the first sensor is a time-of-flight (ToF) sensor, and
wherein the third sensor is an infrared (IR) touch sensor.

15. The operating method of claim 12, further comprising:
obtaining, in response to the electronic device being in the floor-projection orientation and the first sensor being deactivated, pre-stored keystone correction information; and
performing keystone correction by using the obtained keystone correction information.

16. The operating method of claim 14, further comprising:
based on receiving a keystone correction command signal via a user input when the electronic device is in the floor-projection orientation, deactivating the third sensor and activating the first sensor; and
performing keystone correction, based on information obtained via the first sensor.

17. The operating method of claim 16, further comprising, after performing the keystone correction based on the information obtained via the first sensor, deactivating the first sensor and activating the third sensor.

18. The operating method of claim 16, further comprising:
indicating, based on receiving the keystone correction command signal, a suspension of touch recognition; and
after performing the keystone correction, indicating that touch recognition is possible.

19. The operating method of claim 12, further comprising, based on the electronic device being in the wall-projection orientation, preventing an IR touch function from being performed, regardless of whether third sensor is activated.

20. A computer-readable recording medium having recorded thereon a program for causing a computer to execute at least:
obtain rotation state information about the electronic device;
identify, by using the rotation state information about the electronic device, whether the electronic device is in a wall-projection orientation or a floor-projection orientation;
deactivate, based on the electronic device being in the floor-projection orientation, a first sensor; and
activate, based on the electronic device being in the wall-projection orientation, the first sensor.
